(19) United States
(12) Patent Application Publication
(10) Pub. No.: US 2016/0248672 A1
(43) Pub. Date: Aug. 25, 2016

(54) INFORMATION PROCESSING DEVICE, VERIFICATION METHOD AND SYSTEM

(71) Applicant: FUJITSU LIMITED, Kawasaki-shi (JP)

(72) Inventor: Toshihiko Kurita, Kawasaki (JP)

(73) Assignee: FUJITSU LIMITED, Kawasaki-shi (JP)

(21) Appl. No.: 15/016,701

(22) Filed: Feb. 5, 2016

(30) Foreign Application Priority Data
Feb. 20, 2015 (JP) 2015-032122
Oct. 7, 2015 (JP) 2015-199780

(51) Int. Cl. H04L 12/741; H04L 12/751; H04W 72/04

(52) U.S. Cl. CPC H04L 45/745; H04W 72/0446; H04L 45/02

(57) ABSTRACT

An information processing device includes a memory; and a processor coupled to the memory and configured to: generate a packet including a transmission source address, a destination address, and bandwidth information which correspond to a communication route and a bandwidth, based on a request to a network for allocation of the communication route and the bandwidth, specify a transfer route of the generated packet, based on routing tables respectively owned by a plurality of nodes on the network, and determine whether the specified transfer route matches the communication route, based on a transmission source address and a destination address of a packet that reaches a final node using the transfer route.

### CROSS-REFERENCE TO RELATED APPLICATIONS

This application is based upon and claims the benefit of priority of the prior Japanese Patent Application No. 2015-032122, filed on Feb. 20, 2015, and Japanese Patent Application No. 2015-199780, filed on Oct. 7, 2015, the entire contents of which are incorporated herein by references.

### FIELD

The embodiments discussed herein are related to an information processing device, a verification method of a route on a network, and a system.

### BACKGROUND

As a technology related to network control, software defined networking (SDN) has been increasingly drawing attention in recent years. In the SDN, software centrally controls communication devices that constitute a network. The SDN also enables flexible and dynamic changing of a network structure, configuration, setting, or others. This is expected to advance programmability and opening of a network in the future. As related art, the followings are disclosed: Japanese Laid-open Patent Publication No. 2005-191763, Japanese Laid-open Patent Publication No. 2009-130909, International Publication Pamphlet No. WO2011/083786, Japanese Laid-open Patent Publication No. 2004-215006, Japanese Laid-open Patent Publication No. 2008-11538, and others.

In SDN, a network user using a network is allowed to change the network using software. If the network user changes the network, however, a possibility of the occurrence of inconsistency or an unexpected event is higher than in a case where a network provider providing the network totally manages the entire network. For example, in the network, a packet may not be transferred to a transfer destination or a bandwidth may not be reserved in some cases. For this reason, it is preferable that a network route and bandwidth can be verified.

### SUMMARY

According to an aspect of the invention, an information processing device includes a memory; and a processor coupled to the memory and configured to: generate a packet including a transmission source address, a destination address, and bandwidth information which correspond to a communication route and a bandwidth, based on a request to a network for allocation of the communication route and the bandwidth, specify a transfer route of the generated packet, based on routing tables respectively owned by a plurality of nodes on the network, and determine whether the specified transfer route matches the communication route, based on a transmission source address and a destination address of a packet that reaches a final node using the transfer route.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating flow of designing a network;

FIG. 2 is a diagram illustrating one example of a schematic configuration of an overall system;

FIG. 3 is a diagram illustrating one example of a functional configuration of a routing table verification device;

FIG. 4 is a diagram schematically illustrating one example of a network stored in network information;

FIG. 5 is a diagram illustrating one example of a data configuration of demand information;

FIG. 6A is a diagram illustrating an example of a data configuration of a routing table;

FIG. 6B is a diagram illustrating one example of a data configuration of a routing table;

FIG. 6C is a diagram illustrating one example of a data configuration of a routing table;

FIG. 7 is a diagram illustrating one example of a data configuration of a link bandwidth management table;

FIG. 8 is a diagram illustrating one example of a header of a packet according to example 1;

FIG. 9 is a diagram illustrating one example of bit operation;

FIG. 10A is a diagram illustrating one example of a result of calculation of a transfer route of a packet corresponding to demand;

FIG. 10B is a diagram illustrating one example of a result of calculation of a transfer route of an undemanded packet;

FIG. 11 is a diagram illustrating one example of transfer routes;

FIG. 12 is a diagram illustrating one example of a link bandwidth management table;

FIG. 13 is a flow chart illustrating one example of a verification process procedure according to the example 1;

FIG. 14 is a flow chart illustrating one example of a transfer route calculation process procedure according to the example 1;

FIG. 15 is a diagram illustrating one example of a configuration of a header of a packet according to an example 2;

FIG. 16 is a diagram illustrating one example of a head of a packet according to the example 2;

FIG. 17 is a diagram illustrating one example of a result of calculation of a transfer route of a packet corresponding to demand;

FIG. 18 is a diagram illustrating one example of transfer routes;

FIG. 19 is a flow chart illustrating one example of a verification process procedure according to the example 2;

FIG. 20 is a flow chart illustrating one example of a transfer route calculation process procedure according to the example 2;

FIG. 21 is a diagram illustrating one example of a functional configuration of a routing table verification device;

FIG. 22 is a diagram schematically illustrating address conversion;

FIG. 23A is a diagram illustrating one example of parallel movement;

FIG. 23B is a diagram illustrating one example of bit shifting;

FIG. 24A is a diagram illustrating one example of a method of determining an address of an undemanded packet;

FIG. 24B is a diagram illustrating one example of a method of determining an address of an undemanded packet;

FIG. 25 is a diagram schematically illustrating an address and a complementary address in address spaces;

FIG. 26 is a diagram schematically illustrating conversion of verification environment;

FIG. 27A is a diagram illustrating one example of the verification environment before conversion;

FIG. 27B is a diagram illustrating one example of the verification environment after conversion;

FIG. 28A is a diagram illustrating one example of the verification environment before conversion;

FIG. 28B is a diagram illustrating one example of the verification environment after conversion;

FIG. 29A is a diagram illustrating one example of the verification environment before conversion;

FIG. 29B is a diagram illustrating one example of the verification environment after conversion;

FIG. 30 is a flow chart illustrating one example of a generation process procedure according to an example 3;

FIG. 31 is a flow chart illustrating one example of a conversion process procedure according to the example 3;

FIG. 32 is a diagram illustrating one example of a packet header;

FIG. 33 is a diagram illustrating one example of a data configuration of a link bandwidth management table;

FIG. 34 is a diagram schematically illustrating an example of verifying whether a routing table set for a network satisfies a demand;

FIG. 35A, FIG. 35B and FIG. 35C are diagrams schematically illustrating other example of verification flow; and

FIG. 36 is a diagram illustrating a computer configured to execute a routing table verification program.

### DESCRIPTION OF EMBODIMENTS

A routing table verification device as one example of an information processing device and examples of a verification method according to the embodiments are hereinafter described in detail with reference to the drawings. These examples shall not limit this disclosure, and may be combined as occasion calls without departing from the content of processing.

### EXAMPLE 1

First, network designing and verification are described. In recent years, it is believed that in a network, communication devices, which constitute the network, may be intensively controlled by software. Thus, there is SDN as a technology related to network control. The SDN intensively controls communication devices, which constitute a network, with software. Then, the SDN enables flexible and dynamic changing of a network structure, configuration, or setting.

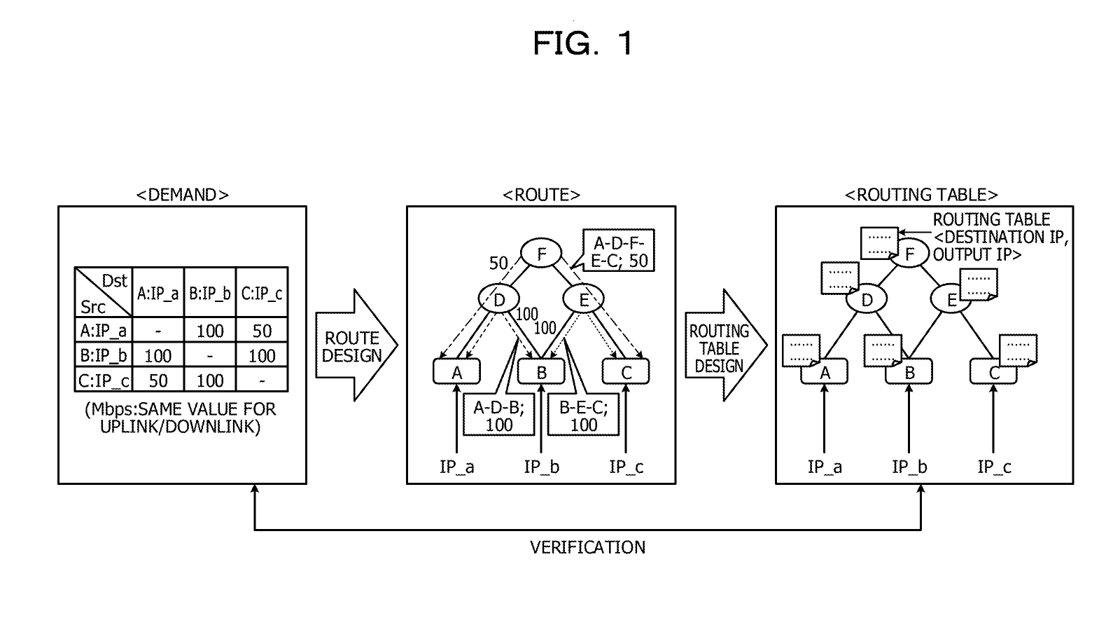

In the SDN, a network user using a network may change a network with software. FIG. 1 is a diagram schematically illustrating flow of designing a network. A network user enters a demand for a network. For example, the network user enters a demand requesting allocation of a communication route and bandwidth for the network. In the example of FIG. 1, as a demand, a bandwidth in a communication route, which is associated with a transmission source and a transmission destination of the communication route and is desirably reserved, is illustrated in a matrix. An item “Src” of the demand is an area to store a transmission source of the transmission route. An item “Dst” of the demand is an area to store a transmission destination of the transmission route. In the example of FIG. 1, information on a node A, a node B, and a node C, which are terminal nodes of the network as the transmission source and destination, and a node address of the transmission source or a node address of the destination are set. For example, “Node A: IP_a”, “Node B: IP_b”, and “Node C: IP_c” are set for the transmission source and destination. The node address of the transmission source or the node address of the destination may be an address of an edge node. A numeric value indicating a bandwidth to be desirably reserved is set for an area corresponding to a transmission source and a destination of a demand. The example of FIG. 1 illustrates that a bandwidth to be desirably reserved between the transmission source “Node A: IP_a” and the destination “Node B: IP_b” is “100” Mbps. The example of FIG. 1 further illustrates that a bandwidth that is desirably reserved between the transmission source “Node A: IP_a” and the destination “Node C: IP_c” is “50” Mbps. The example of FIG. 1 further illustrates that a bandwidth that is desirably reserved between the transmission source “Node B: IP_b” and the destination “Node C: IP_c” is “100” Mbps. An area for which “-” is set indicates that no communication route is set.

In designing of a network, a route is designed according to a demand. For example, in the network designing, a route is set for each node, which constitutes an actual network, according to a communication route and a bandwidth of a demand. The example of FIG. 1 illustrates that, as “A-D-B; 100”, a route of 100 Mbps is reserved for a route of the node A, a node D, and the node B. The example of FIG. 1 illustrates that as “A-D-F-E-C; 50”, a route of 50 Mbps is reserved for a route of the node A, the node D, a node F, a node E, and the node C.

In the network designing, with each communication device, which constitutes the actual network, as a node, a routing table of each node is generated according to a route design. For example, in the network designing, entry information of a routing table set for each node is derived from route information of route designing.

As such, if a network is made changeable by a network user, it is more likely that inconsistency or an unexpected event occurs in network operation, when compared with a case in which a network provider providing the network totally consolidates management of the network. For example, there are some cases in which a packet is no longer transferred to a transfer destination in a network, or a bandwidth may not be reserved. Thus, in this example, validity of a generated routing table is verified on software before the generated routing table is applied to the actual network. For example, it is verified whether or not a generated routing table of each node satisfies an original demand or contains any mistake. Application of the routing table to the actual network after such verification is performed may control occurrence of inconsistency or an unexpected event in operation of the actual network.

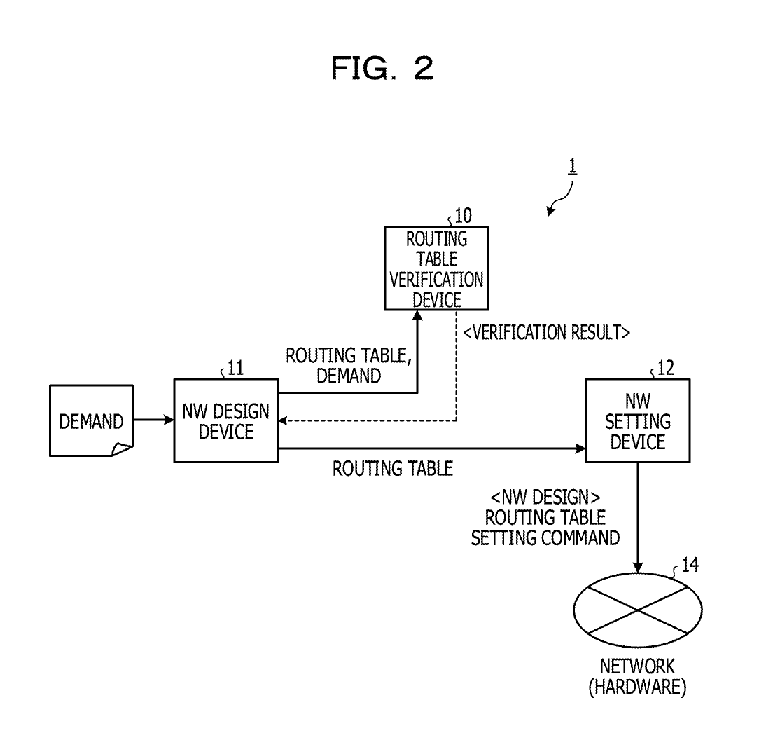

A system 1 according to this example is described hereinafter. The system 1 applies SDN and intensively controls communication devices, which constitute an actual network 14, by way of software. FIG. 2 is a diagram illustrating one example of a schematic configuration of an overall system. The system 1 includes a routing table verification device 10, a network (NW) design device 11, and a NW setting device 12.

The NW design device 11 is a device configured to perform network designing. The NW design device 11 is, for example, a computer such as a personal computer or a server computer. The NW design device 11 accepts input of a demand requesting a network 14 to allocate a communication route and a bandwidth. For example, the NW design device 11 accepts, as a demand, input of a transmission source and a transmission destination of a communication route, and a bandwidth that is desirably reserved in a communication route. The NW design device 11 designs a route over which a packet is transferred, according to the demand. Then, the NW design device 11 generates a routing table of each node that constitutes the actual network 14, according to the designed routes. The NW design device 11 transmits to a routing table verification device 10 the accepted demand and the generated routing table for each node, and requests verification.

The routing table verification device 10 is a device configured to verify a routing table. The routing table verification device 10 is, for example, a computer such as a personal computer or a server computer. The routing table verification device 10 verifies whether a routing table of each node satisfies the original demand and whether the routing table includes a mistake, and notifies the NW design device 11 of a verification result.

If there is no abnormality in the verification result by the routing table verification device 10, the NW design device 11 transmits the routing table of each node to the NW setting device 12.

The NW setting device 12 is a device configured to perform various settings on the actual network 14. The NW setting device 12 is, for example, a computer such as a personal computer or a server computer. The NW setting device 12 uses a predetermined setting command that sets a node-specific routing table to set the routing table in each node on the network 14. With this, a structure, a configuration, or setting of the network 14 is changed, and the communication route and the bandwidth requested as a demand are reserved. In the system 1, before a routing table is set for the actual network 14, the routing table verification device 10 verifies the routing table. In the system 1, this may control occurrence of any inconsistency or an unexpected event in operation of a network, even when a network user changes the network.

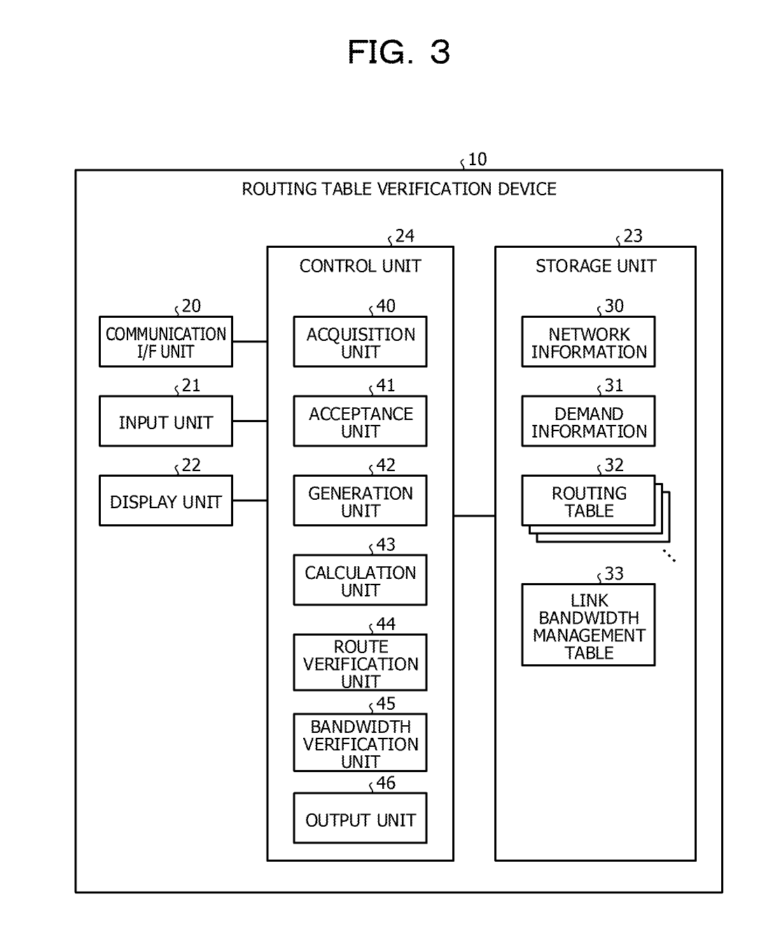

A configuration of the routing table verification device 10 according to this example is described hereinafter. FIG. 3 is a diagram illustrating one example of a functional configuration of a routing table verification device. As illustrated in FIG. 3, the routing table verification device 10 includes a communication interface (I/F) unit 20, an input unit 21, a display unit 22, a storage unit 23, and a control unit 24. The routing table verification device 10 may have any device other than the above-mentioned devices.

The communication I/F unit 20 is an interface configured to control communications with other devices. As a communication I/F device 20, a network interface card such as a LAN card may be adopted.

The communication I/F unit 20 transmits and receives various types of information to and from other devices by way of a network, not shown. For example, the communication I/F unit 20 receives information on a demand accepted from the NW design device 11 and a routing table of each node.

The input unit 20 is an input device configured to input various types of information. The input device 21 may include an input device that accepts input of manipulation, such as a mouse or a keyboard. The input unit 21 accepts input of various types of information. For example, the input unit 21 accepts various manipulation input related to verification. The input unit 21 accepts operation input from a user, and inputs to the control unit 24 operation information indicating content of the accepted operation.

The display unit 22 is a display device configured to display various types of information. The display unit 22 includes a display device such as a liquid crystal display (LCD) or a cathode ray tube (CRT). The display unit 22 displays various types of information. For example, the display unit 22 displays various types of screens related to verification, such as various operation screens or a screen indicating a verification result.

The storage unit 23 is a storage device configured to store various types of data. For example, the storage unit 23 is, for example, a storage device such as a hard disk, a solid state drive (SSD), an optical disk, or the like.

The storage unit 23 may be a semiconductor memory capable of rewriting data, such as a random access memory (RAM), a flash memory, a non-volatile static random access memory (NVSRAM).

The storage unit 23 stores an operating system (OS) or various types of programs executed by the control unit 24. For example, the storage unit 23 stores various types of programs, including a program that performs various types of processes, as described below. Furthermore, the storage unit 23 stores various types of data to be used in a program executed by the control unit 24. For example, the storage unit 23 stores network information 30, demand information 31, a routing table 32, and a link bandwidth management table 33.

The network information 30 is data that stores various types of information related to the actual network 14. For example, the network information 30 stores a network topology that indicates a connection relation with each communication device, which constitutes the network 14, as a node, as well as settings of each node. The network information 30 stores information of a bandwidth amount of a link between connected nodes.

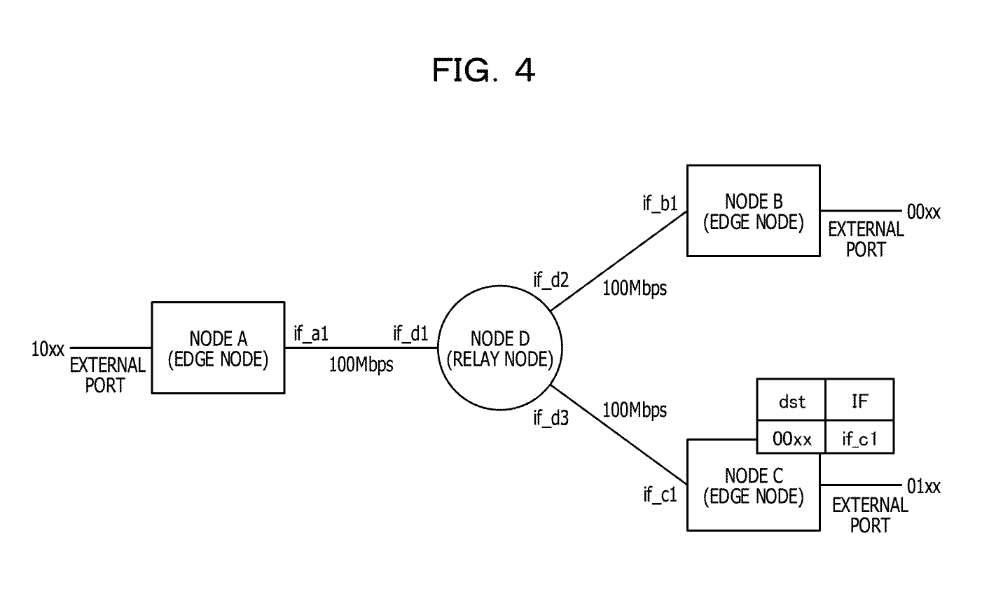

FIG. 4 is a diagram schematically illustrating one example of a network stored in network information. In the example of FIG. 4, the network 14 includes a node A, a node B, a node C, and a node D, and the node A, the node B, and the node C are connected by way of the node D. The node A, the node B, and the node C are an edge node configured to perform communications with the outside. The node D is a relay node configured to relay data from the edge node.

The node A includes an external port having an address of “10XX” and an interface if_a1, and is connected with the node D by way of the interface if_a1. The node B includes an external port having an address of “00XX” and an interface if_b1, and is connected with the node D by way of the interface if_b1. The node C includes an external port having an address of “01XX” and an interface if_c1, and is connected with the node D by way of the interface if_c1. The node D includes interfaces if_d1, if_d2, if_d3, and is connected with the node A by way of the interface if_d1, the node B by way of the interface if_d2, and the node C by way of the interface if_d3. In this example, for simplicity, an address is indicated in 4 bits such as “10XX”, for example. “X” in an address represents a wildcard that may substitute any applicable address bit, irrespective of whether the address bit is “0” or “1”.

Turning back to FIG. 3, the demand information 31 is data storing demand information requested for the network 14. For example, in the demand information 31 is stored information on a communication route and a bandwidth that are requested for the network 14.

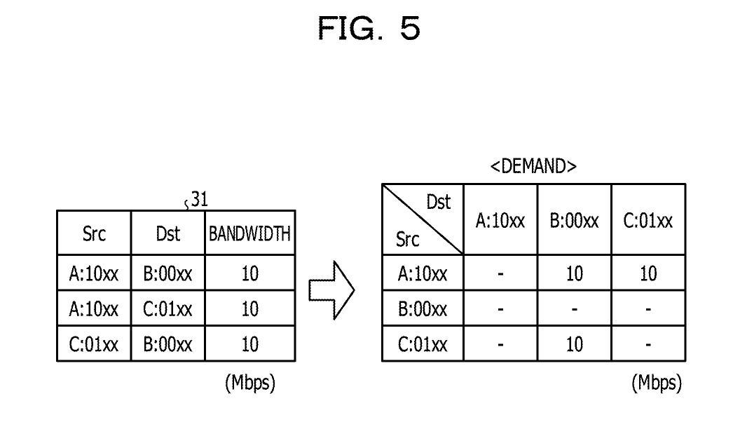

FIG. 5 is a diagram illustrating one example of a data configuration of demand information. As illustrated in FIG. 5, the demand information 31 has respective items of “Src”, “Dst”, and “Band”. The item Src is an area to store a transmission source of a communication route allocation of which is requested. The Dst item is an area to store a destination of the communication route allocation of which is requested. The item bandwidth is an area to store a bandwidth allocation of which for the communication route is requested. On the right side of FIG. 5, a bandwidth that is associated with a transmission source and a transmission destination of a communication route and that is desirably reserved is illustrated in a matrix. An area where “-” is set indicates that no communication route is set. The example of FIG. 5 illustrates that a bandwidth that is desirably reserved between the transmission source “node A: 10xx” and the destination “node B: 00xx” is “10” Mbps. Furthermore, the example FIG. 5 illustrates that a bandwidth that is desirably reserved between the transmission source “node A: 10xx” and the destination “node C: 01xx” is “10” Mbps. Furthermore, the example of FIG. 5 illustrates that a bandwidth that is desirably reserved between the transmission source “node C: 01xx” and the destination “node B: 00xx” is “10” Mbps.

Turning back to FIG. 3, the routing table 32 is data that stores entry information defining a route on which a packet of each node is transferred. For example, in the routing table 32, an output destination has been stored depending on a packet destination, for each entry information.

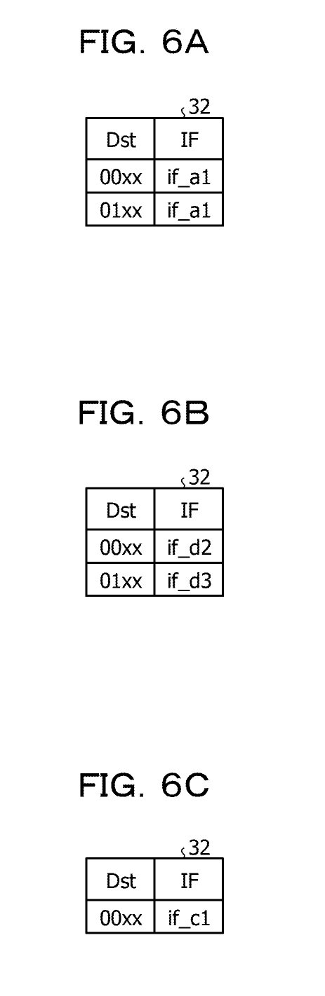

FIGS. 6A to 6C are diagrams illustrating an example of a data configuration of a routing table. In this example, in order to simplify the description, the routing table 32 indicates only an output destination corresponding to a destination, as entry information. FIG. 6A illustrates one example of a routing table of the node A. FIG. 6B illustrates one example of a routing table of the node D. FIG. 6C illustrates one example of a routing table of the node C. As illustrated in FIGS. 6A to 6C, the routing table 32 has each item of “Dst” and “IF”. The Dst item is an area to store a packet destination. The IF item is an area to store an output destination of a packet. Each record of the routing table 32 corresponds to the entry information. In the example of FIG. 6A, a packet with destinations “00xx” and “01xx” indicates that the output destination is the interface if_a1. In the example of FIG. 6B, a packet with a destination “00xx” indicates that the output destination is the interface if_d2. A packet with a destination “01xx” indicates that the output destination is the interface if_d3. In the example of FIG. 6C, a packet with a destination “00xx” indicates that the output destination is the interface if_c1.

Turning back to FIG. 3, the link bandwidth management table 33 represents data storing information on a bandwidth of each link between nodes. For example, the routing table 32 stores a bandwidth used and an available bandwidth amount for each link between nodes.

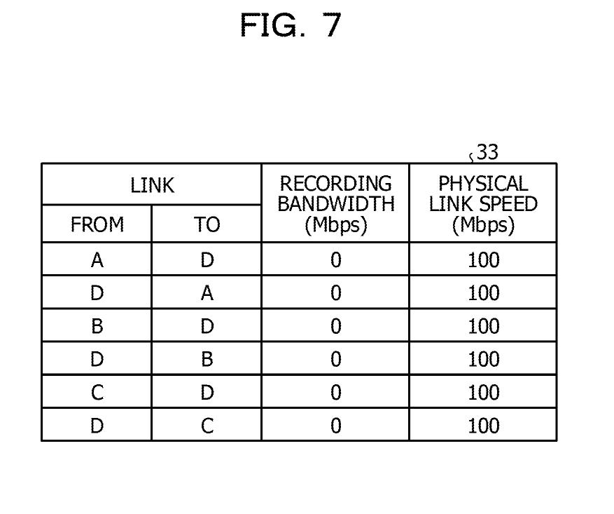

FIG. 7 is a diagram illustrating one example of a data configuration of a link bandwidth management table. As illustrated in FIG. 7, the link bandwidth management table has respective items of “Link”, “Recording Band”, and “Physical Link Speed”. The link item is divided to items “from” and “to”. The from item is an area to store a node that is a transmission source of a packet in a link. The to item is an area to store a node that is a transmission destination of a packet in a link. The recording bandwidth item is an area to store a summed-up value of bandwidths of packets that pass through a link. An initial value of 0 is set for the recording bandwidth item. The physical link speed item is an area to store physical link speed of a link as an available bandwidth amount. For example, an upper limit of transmission speed of a cable or the like, which constitutes a link, is used for the physical link speed of the link. The example of FIG. 7 indicates that for a link from the node A to the node D, the recording bandwidth is 0 Mbps and the available bandwidth amount is 100 Mbps.

Turning back to FIG. 3, the control unit 24 is a device configured to control the routing table verification device 10. As the control unit 24, an electronic circuit such as a central processing unit (CPU), a micro processing unit (MPU) or the like or an integrated circuit such as an application specific integrated circuit (ASIC), a field programmable gate array (FPGA) or the like may be adopted. The control unit 24 has an internal memory to store programs and control data that defines various types of processing procedures with which various processes are performed. The various types of programs running, the control unit 24 acts as various processing units. For example, the control unit 24 includes an acquisition unit 40, an acceptance unit 41, a generation unit 42, a calculation unit 43, a route verification unit 44, a bandwidth verification unit 45, and an output unit 46.

The acquisition unit 40 is configured to perform various acquisition processes. For example, the acquisition unit 40 acquires demand information or a routing table of each node from the NW design device 11. Information to be acquired may be voluntarily transmitted by the NW design device 11. The acquisition unit 40 may request the NW design device 11 to transmit information to be acquired and the NW design device 11 may transmit the information in response to the request. The acquisition unit 40 stores the acquired information in the storage unit 23. For example, the acquisition unit 40 stores acquired demand information in the demand information. The acquisition unit 40 stores the acquired routing table of each node in the routing table 32.

The acceptance unit 41 is configured to perform various acceptance processes. The acceptance unit 41 accepts various operation instructions. For example, the acceptance unit 41 causes the display unit 22 to display an operation screen related to verification and accepts an operation instruction such as verification start or the like from the input unit 21. In this example, although the acceptance unit 41 is illustrated as accepting an operation instruction such as verification start or the like from the input unit 21, the acceptance unit may cause other device to display an operation screen and remotely accept an operation instruction from the other device. The acceptance unit 41 may consider acquisition of demand information or a routing table of each node from the NW design device 11 acceptance of verification start.

The generation unit 42 is configured to perform various generation processes. For example, the generation unit 42 generates a packet including a transmission source address, a destination address, and bandwidth information corresponding to a communication route and a bandwidth, based on each demand stored in the demand information 31. For example, the generation unit 42 extends a packet header so as to be able to accommodate the bandwidth information. For an area to be extended, an unused area of a header may be used or a new area may be added to the header. The generation unit 42 extends a packet header to generate a packet including a transmission source address, a destination address, and bandwidth information corresponding to a communication route and a bandwidth.

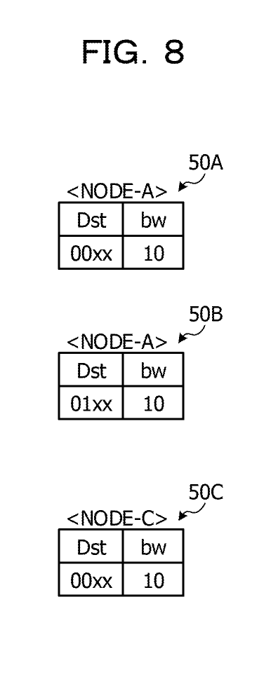

FIG. 8 is a diagram illustrating one example of a header of a packet according to example 1. In this example, in order to simplify a description, only a destination and a bandwidth of a packet header are illustrated. Dst represents a destination, and bw represents a bandwidth. For example, the demand information 31 stores the demands illustrated in FIG. 5. In this case, the generation unit 42 generates a packet 50A with Dst of a header as “00xx” corresponding to a transmission source “Node A:10xx”, a destination “Node B:00xx”, and a bandwidth to be desirably reserved “10” Mbps, and bw as “10”. The generation unit 42 generates a packet 50B with Dst of the header as “01xx” corresponding to a transmission source “Node A:10xx”, a destination “Node C:01xx”, and a bandwidth to be desirably reserved “10” Mbps, and bw as “10”. The generation unit 42 generates a packet 50C with Dst of the header as “00xx” corresponding to a transmission source “Node C:01xx”, a destination “Node B:00xx”, and a bandwidth to be desirably reserved “10” Mbps, and bw as “10”.

The generation unit 42 may generate a packet including transmission source node information, destination node information, a transmission source address, a destination address, and bandwidth information. For example, the generation unit 42 may also generate a packet that stores, in a header, information indicating an edge node of a transmission source that is an entrance of the packet as the transmission source node information; an address of the edge node of the transmission source as the transmission source address; information indicating an edge node of a destination that is an exit of the packet as the destination node information; an address of the edge node of the transmission source as the transmission source address; and an address of the edge node of the destination as the destination address. For example, the generation unit 42 may also generate the packet 50A with the header transmission source node information as “A”, which is the node of the transmission source, the destination node information as “B”, which is the node of the destination, Dst as “00xx”, and bw as “10”, corresponding to the transmission source “Node A:10xx”, the destination “Node B:00xx”, and the bandwidth to be desirably reserved “10” Mbps.

The generation unit 42 generates an undemanded packet that does not correspond to any of demands stored in the demand information 31. For example, when a demand has D1 and D2 as a destination address, the generation unit 42 generates an undemanded packet with an address D0 as a destination, the address D0 being a complement set of a sum of D1 and D2, as illustrated in the expression (1) below:

D0=D̅1̅ ∪̅ D̅2̅ (1)

The calculation unit 43 is configured to perform various types of calculation processes. For example, based on the routing table 32, the calculation unit 43 calculates a transfer route of each packet generated by the generation unit 42. For example, the calculation unit 43 inputs a packet corresponding to a demand from a node of a transmission source to the network 14. Then, the calculation unit 43 calculates a transfer route of the packet according to the routing table 32 of each node. The calculation unit 43 inputs an undemanded packet from each edge node to the network 14. Then, the calculation unit 43 calculates a transfer route of a packet according to the routing table 32 of each node.

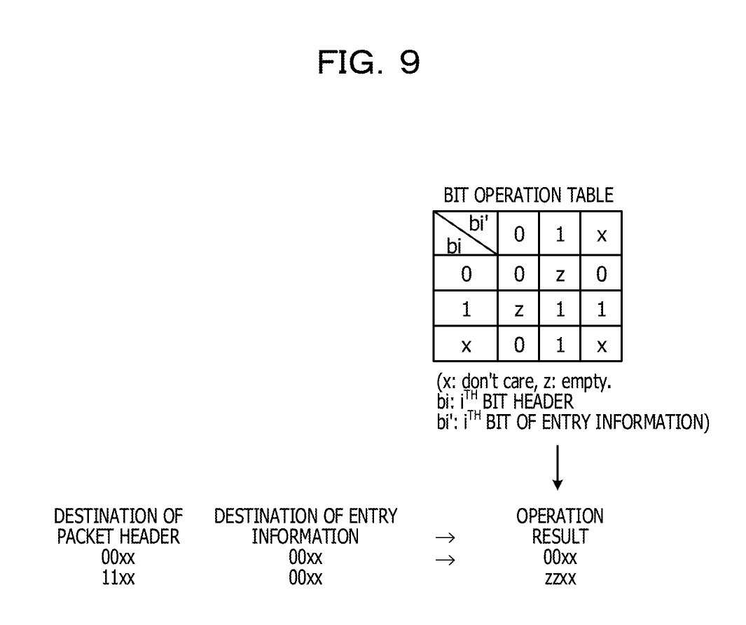

Now, flow of the calculation unit 43 calculating a transfer route is described in detail. For example, for each node that receives a packet, the calculation unit 43 sequentially compares a header of the received packet with each entry information of the routing table 32 of the node to search for the corresponding entry information. For example, the calculation unit 43 sequentially reads the entry information from the routing table 32. Then, the calculation unit 43 performs a bit operation on a destination address of the packet and a destination address of the read entry information. FIG. 9 is a diagram illustrating one example of bit operation. For example, the calculation unit 43 performs a bit operation on a destination address of the packet and a destination address of the read entry information according to a bit operation table as illustrated in FIG. 9. The calculation unit 43 determines whether or not an operation result includes empty. If the operation result includes empty, the calculation unit 43 compares the destination address of the packet with next entry information because the destination address of the packet does not correspond to the destination address of the entry information. If the operation result does not include empty, the calculation unit 43 outputs the packet to an output destination of the corresponding entry information because the destination address of the packet corresponds to the destination address of the entry information. On the one hand, since no packet is transferred if the destination address of the packet does not correspond any of entry information, the calculation unit 43 decides that there is no route.

The calculation unit 43 performs the process described above to calculate a transfer route until the packet is outputted from the edge node or the packet is dropped as there being no route.

If a packet corresponds to a demand in the routing table 32 of each node and is thereby correctly generated, the packet corresponding to the demand is transferred along a communication route of the demand. On the one hand, if the routing table 32 of each node is correctly generated, an undemand packet is dropped in an input port. Thus, a transfer route for each demand may be calculated from a transfer route of a packet calculated by the calculation unit 43.

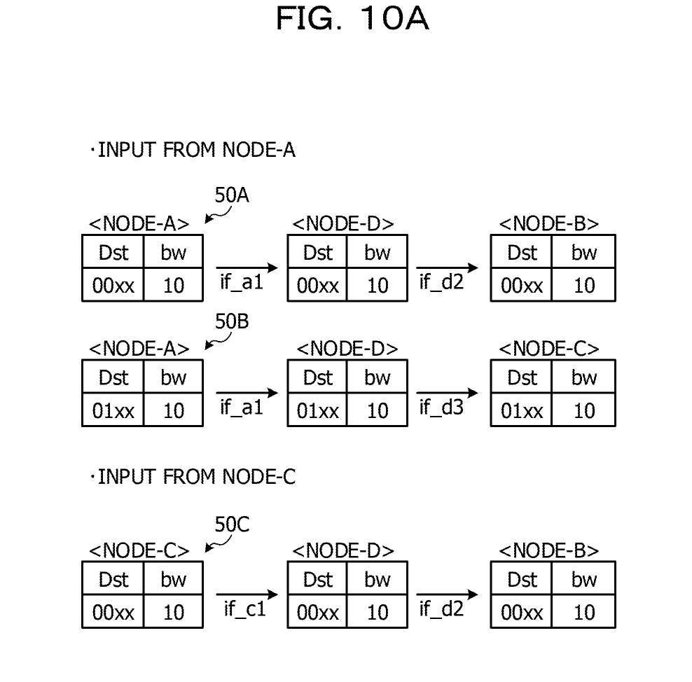

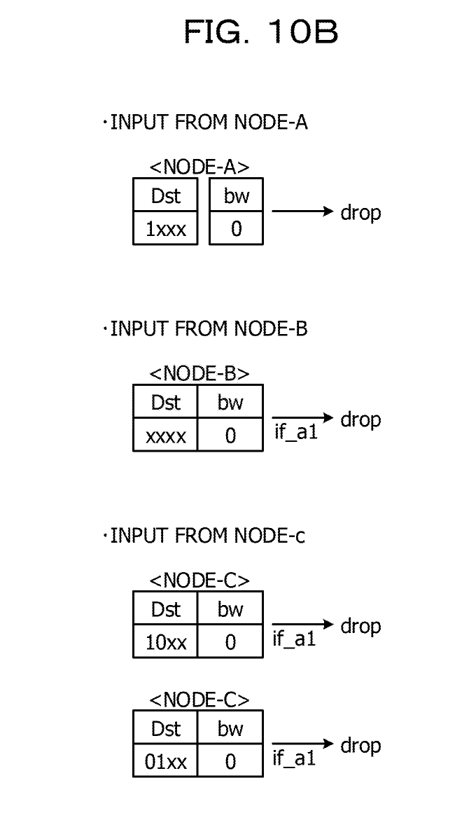

FIG. 10A is a diagram illustrating one example of a result of calculation of a transfer route of a packet corresponding to demand. FIG. 10A illustrates results of calculation of transfer routes of packets 50A to 50C. The packet 50A is inputted from the node A and transferred to the node D and the node B. The packet 50B is inputted from the node A and transferred to the node D and the node C. The packet 50C is inputted from the node C and transferred to the node D and the node B.

FIG. 10B is a diagram illustrating one example of a result of calculation of a transfer route of an undemanded packet. FIG. 10B illustrates results of input of respective undemanded packets from the nodes A, B, and C. As illustrated in FIG. 10B, any of the undemanded packets has no route and is dropped.

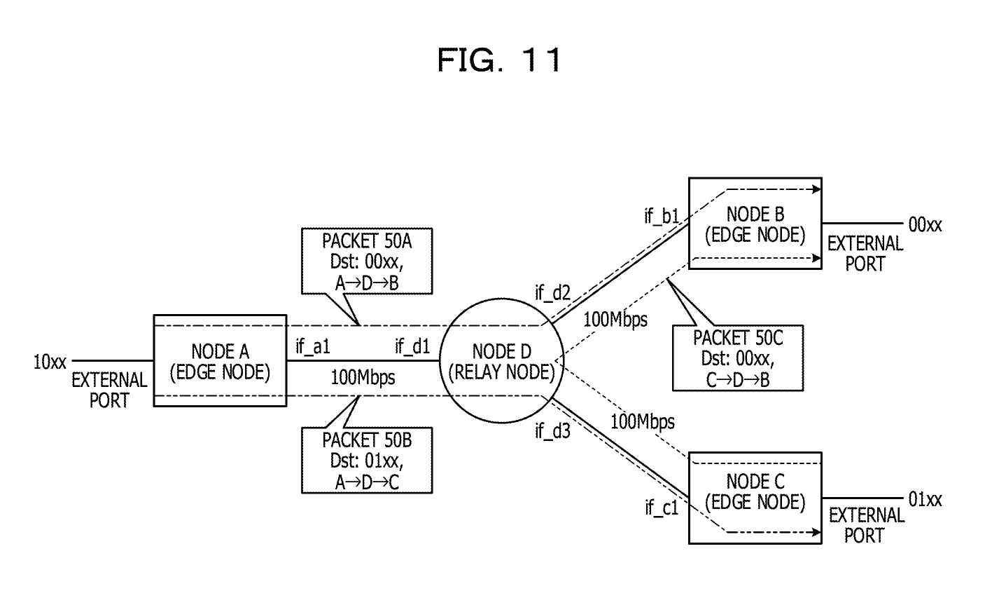

FIG. 11 is a diagram illustrating one example of transfer routes. As illustrated in FIG. 11, the packet 50A is transferred from the node A to the node D, and then transferred from the node D to the node B. Thus, a transfer route for a demand corresponding to the packet 50A is determined to be the node A, the node D, and the node B. The packet 50B is transferred from the node A to the node D, and then transferred from the node D to the node C. Thus, a transfer route for a demand corresponding to the packet 50B is determined to be the node A, the node D, and the node C. The packet 50C is transferred from the node C to the node D, and then transferred from the node D to the node B. Thus, a transfer route for a demand corresponding to the packet 50C is determined to be the node C, the node D, and the node B.

The route verification unit 44 is configured to verify consistency of a communication route. For example, the route verification unit 44 verifies consistency of with a communication route of a demand from a transmission source address and a destination address of a packet that reaches a final node. For example, the route verification unit 44 compares the transmission source address and the destination address of the packet that reaches the final node, respectively, with a transmission source and a destination of a demand. When both addresses match, the route verification unit 44 determines that consistency with the communication route is achieved. On the one hand, when the transmission source address and the destination address of the packet that reaches the final node do not match the transmission source and the destination of the demand, the route verification unit 44 determines that the consistency with the communication route is not achieved. When a transfer route is calculated depending on a transmission source address and a packet reaches an edge node of a network, final node shall be an edge node. On the one hand, if a packet is no longer transferred in any of nodes, a final node shall be a node where any node is no longer transferred. As described below, if verification is performed on whether or not any loop occurs on a transfer route, an upper limit of transfers between nodes may be provided, and a node where the number of transfers reaches the upper limit may be a final node. An upper limit of transfers between nodes may be specified by a user or automatically defined depending on a network to be verified. For example, a value obtained by multiplying a maximum value of the number of nodes between edge nodes of a network with a predetermined multiple (twice, for example) may be an upper limit of the number of transfers allowed between the nodes. Verification of consistency may be performed only for information on an address or a node, or information on both address and node may be used. For example, the route verification unit 44 verifies whether a transmission source address and a destination address of a packet that reaches a final node respectively match a transmission source address and a destination address of a demand corresponding to the packet. The route verification unit 44 verifies whether a final node that a packet reaches and a transmission source node where a packet is first inputted respectively match a destination node and transmission source node of a demand corresponding to the packet. When a packet includes transmission source node information and destination node information, the route verification unit 44 may also verify whether a final node that the packet reaches and a transmission source node where a packet is first inputted match a node in the transmission source node information and a node in the destination node information included in the packet. When a transmission source address and a destination address of a packet that reaches a final node falls within a transmission source and a destination of a demand, the route verification unit 44 may determine that consistency with the communication route is achieved. For each packet that reaches a final node, the route verification unit 44 verifies consistency with a communication route of a demand from a transmission source address and a destination address of the packet.

The route verification unit 44 verifies whether or not a loop occurs on a transfer route as consistency of a communication route. For example, the route verification unit 44 verifies whether or not a loop occurs on a transfer route of a packet calculated by the calculation unit 43. For example, if a packet is outputted again to a node through which the packet passes in a transfer route, the route verification unit 44 determines that a loop occurs. The route verification unit 44 verifies that there is no communication route for an undemanded packet, as consistency of a communication route. For example, the route verification unit 44 verifies whether or not an undemanded packet is dropped without being transferred at any node of a network.

The bandwidth verification unit 45 verifies consistency of a communication bandwidth. For example, the bandwidth verification unit 45 sums up bandwidths for each link between nodes from information on a transfer route calculated by the calculation unit 43 and on bandwidths of packets, and verifies consistency with a bandwidth amount of the link. For example, every time a packet is transferred between nodes in calculation by the calculation unit 43, the bandwidth verification unit 45 accumulates a value of bandwidth of the transferred packet in the link bandwidth management table 33 at the area of the recording bandwidth of the link of the nodes between which the packet is transferred. With this, when the calculation unit 43 finishes calculating the transfer routes, a total bandwidth of transferred packets through the link is recorded in the link bandwidth management table 33.

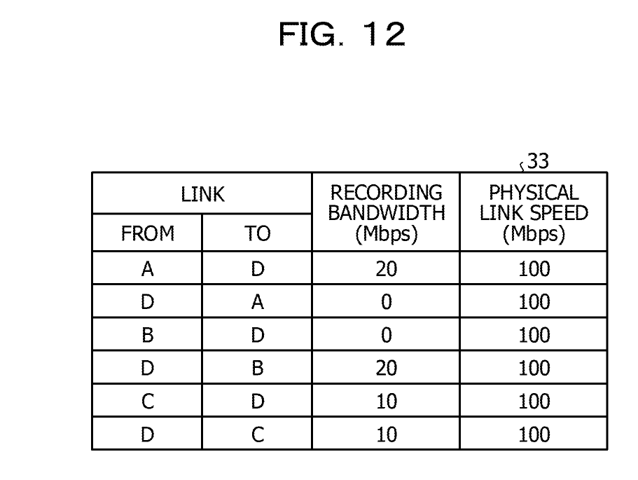

FIG. 12 s a diagram illustrating one example of a link band management table. The example of FIG. 12 illustrates total bandwidths by the link when transfer routes of the packets 50A, 50B, 50C are calculated. A link from the node A to the node D is recorded as having a total bandwidth of 20 Mbps.

The bandwidth verification unit 45 determines for each link whether or not recorded total bandwidth is equal to or lower than a value of physical link speed. When the total bandwidth is equal to or lower than the value of physical link speed, the bandwidth verification unit 45 determines that consistency of a communication bandwidth is achieved. On the one hand, when the total bandwidth is larger than the value of physical link speed, the bandwidth verification unit 45 determines that the consistency of the communication bandwidth is not achieved.

The output unit 46 is configured to perform various types of output. For example, the output unit 46 outputs results of verification of the route verification unit 44 and the bandwidth verification unit 45 to the display unit 22. For example, the output unit 46 outputs information on the results of verification of the route verification unit 44 and the bandwidth verification unit 45 to the NW design device 11 to notify the results of verification.

When there is no abnormality in the verification result notified by the routing table verification device 10, a generated routing table of each node is transferred from the NW design device 11 to the NW setting device 12 and applied to the actual network 14.

In this manner, the routing table verification device 10 verifying a routing table of each node, the system 1 may control occurrence of any inconsistency or unexpected event in operation of the network 14.

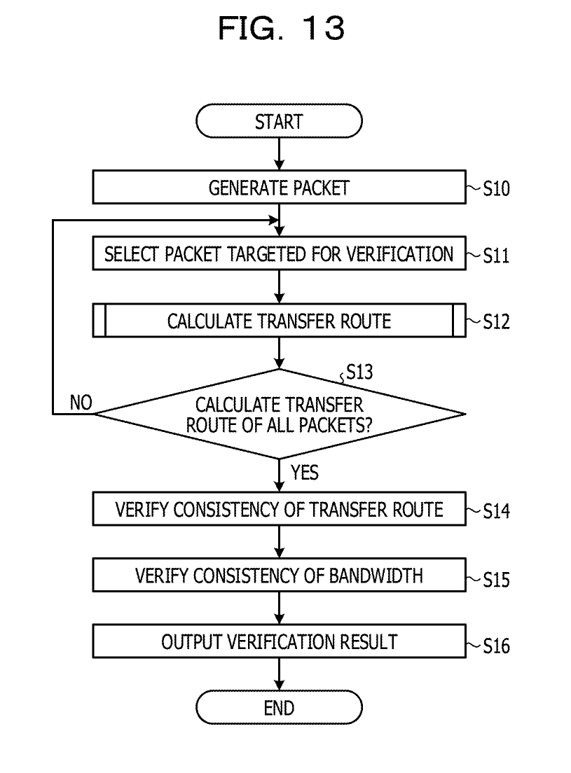

Flow of a verification process according to the example 1 in which the routing table verification device 10 verifies a routing table is described. FIG. 13 is a flow chart illustrating one example of a verification process procedure according to the example 1. This verification process procedure is performed at predetermined timing, such as the timing when an operation instruction to start verification is accepted from the input unit 21.

As illustrated in FIG. 13, the generation unit 42 generates a packet including a transmission source address, a destination address, and bandwidth information corresponding to a communication route and a bandwidth, based on each demand stored in the demand information 31 (S10). The calculation unit 43 selects one packet of generated packets, as a packet targeted for verification (S11).

The calculation unit 43 performs a transfer route calculation process to calculate a transfer route of the packet targeted for verification (S12).

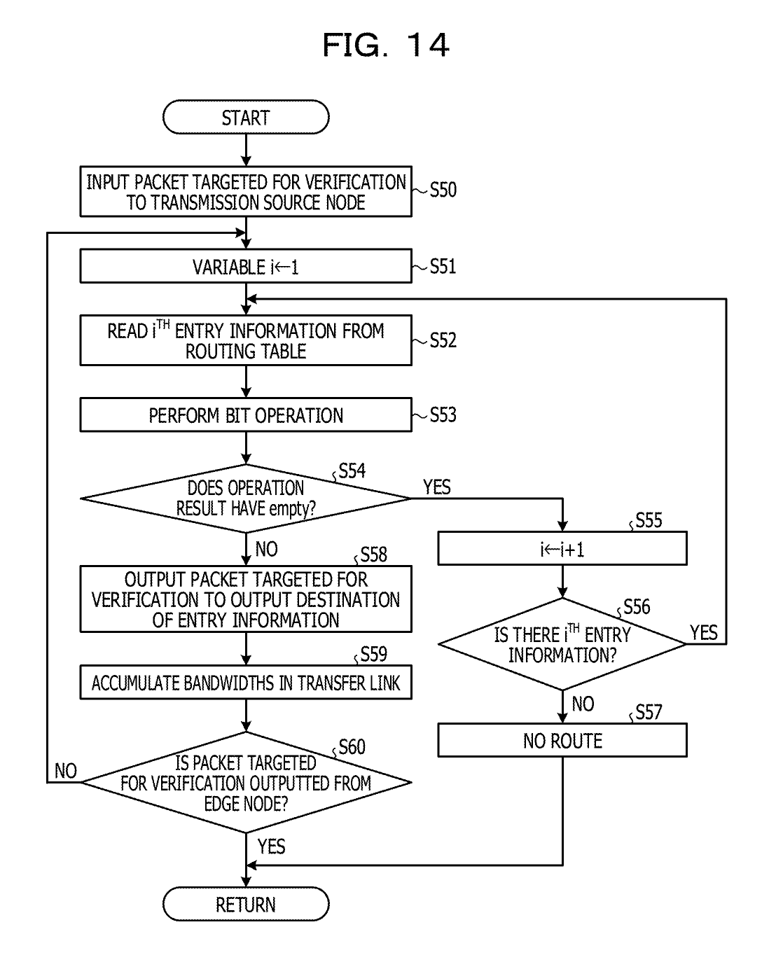

FIG. 14 is a flow chart illustrating one example of a transfer route calculation process procedure according to the example 1. this transfer route calculation process is performed from S12 of the verification process, for example.

As illustrated in FIG. 14, the calculation unit 43 inputs the packet to be verified in a node at a transmission source of the packet to be verified (S50). The calculation unit 43 initializes a variable i to 1 (S51). The calculation unit 43 reads entry information of the i^{th} variable from a routing table of a node that receives the packet (S52). The calculation unit 43 performs a bit operation of a destination address of the packet targeted for verification and a destination address of the read entry information (S53).

The calculation unit 45 determines whether an operation result includes empty (S54). When the operation results includes empty (S54 Affirmative), the calculation unit 43 adds 1 to the value of the variable i (S55). Then, the calculation unit 43 determines whether or not the routing table 32 of the node that receives the packet has the entry information of the i^{th} variable (S56). When the routing table 32 has the entry information of the i^{th} variable (S56 Affirmative), the calculation unit 43 proceeds to S52 mentioned above.

On the one hand, when the routing table 32 does not have the entry information of the i^{th} variable (S56 Negative), there is no transfer destination of the packet. Thus, with no route (S57), the calculation unit 43 finishes the transfer route calculation process and proceeds to S13 of the verification process.

On the one hand, when the operation result does not include empty (S54 Negative), the calculation unit 43 outputs the packet targeted for verification to an output destination of the entry information (S58).

The bandwidth verification unit 45 sums up a value of a bandwidth of the packet to be verified, in the area of the link bandwidth management table 33 for a recording bandwidth of the link of the nodes between which the packet targeted for verification is transferred (S59).

The calculation unit 43 determines whether or not the packet targeted for verification is outputted from an edge node (S60). When the packet targeted for verification is outputted from the edge node (S60 affirmative), calculation unit 43 finishes the transfer route calculation process and shifts to S13 of the verification process.

On the one hand, when the packet targeted for verification is not outputted from the edge node (S60 negative), the calculation unit 43 shifts to S51 mentioned above to perform a calculation process of a route for the node inputted by the packet targeted for verification.

Returning to FIG. 13, the calculation unit 43 determines whether or not the calculation unit performs a transfer route calculation process on all generated packets (S13). When the calculation unit 43 does not perform a transfer route calculation process on all packets (S13 negative), the calculation unit 43 shifts to S11 mentioned above.

On the one hand, when the calculation unit 43 performs a transfer route calculation process on all the packets (S13 affirmative), the route verification unit 44 verifies consistency with a transfer route of each packet generated and a communication route of a demand (S14). Comparing the total bandwidth by the link recorded in the link bandwidth management table 33 with the physical link speed, the bandwidth verification unit 45 verifies consistency of a band by the link (S15).

The output unit 46 outputs to the NW design device 11 information on results of the route verification unit 44 and the bandwidth verification unit 45 (S16) and finishes the process.

As described above, the routing table verification device 10 according to this example generates a packet including a transmission source address, a destination address, and bandwidth information corresponding to a communication route and a bandwidth based on a demand requesting the network 14 to allocate the communication route and the bandwidth. The routing table verification device 10 calculates a transfer route of the generated packet, based on the routing table of each node of the network 14. The routing table verification device 10 verifies consistency with a communication route of a demand from a transmission source address and a destination address of a packet that reaches a final node, due to calculation. The routing table verification device 10 sums up bandwidths for the link between nodes to verify consistency with the bandwidth amount of the link. This allows the routing table verification device 10 to verify a route and a bandwidth of the network.

The routing table verification device 10 according to the example generates, for each demand, a packet including a transmission source address, a destination address, and bandwidth information corresponding to a communication route and a bandwidth of the demand. The routing table verification device 10 calculates a transfer route for each generated packet. For each packet that reaches a final node, the routing table verification device 10 verifies consistency with a communication route of a demand from a transmission source address and a destination address of the packet. For each link between nodes, the routing table verification device 10 sums up bandwidths of packets passing through the link to verify integrity with the bandwidth amount of the link. This allows the routing table verification device 10 to verify a route and a bandwidth of a network for each demand.

### EXAMPLE 2

An example 2 is described hereinafter. A configuration of a system 1 and a routing table verification device 10 according to the example 2 is similar to the example 1 illustrated in FIGS. 2 and 3. Thus, different parts are mainly described.

In the example 2, for each demand for which a transmission source is a same node, a generation unit 42 generates a packet with a header consolidating each demand. For example, for each node for which a transmission source is same, the generation unit 42 generates a packet including a consolidated type demand header that consolidates a transmission source address and a destination address of each demand, and as well as the transmission source address, the destination address, and bandwidth information of each demand, as a demand list. More specifically, the generation unit 42 extends a packet header so that the bandwidth information may be accommodated. For an area to be extended, an unused area of a header may be used or a new area may be added to the header. The generation unit 42 determines a consolidated transmission source address which is a logical sum of the transmission source addresses of demands and a consolidated destination address which is a logical sum of the destination addresses of the demands. Then, the generation unit 42 generates a packet including the transmission source address and the destination address which are consolidated as a consolidated demand header, and the transmission source address, the destination address, and the bandwidth information of each demand as the demand list.

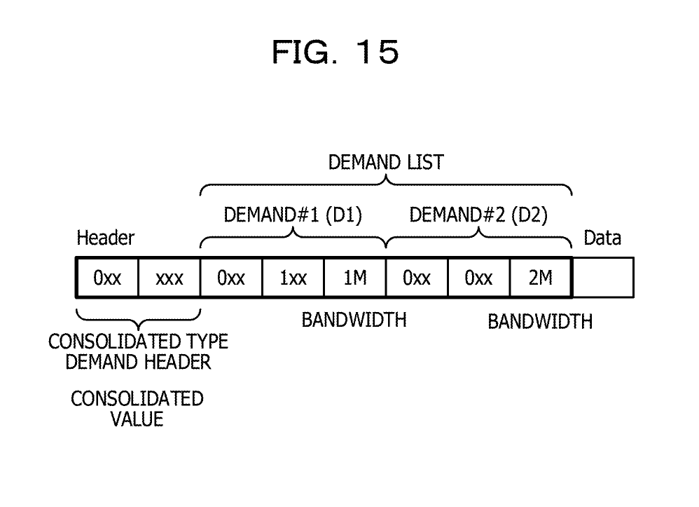

FIG. 15 is a diagram illustrating one example of a configuration of a header of a packet according to an example 2. As illustrated in FIG. 15, a packet header has an area to store consolidated transmission source address and destination address as a consolidated type demand header, as well as a transmission source address, a destination address, and bandwidth information of each demand, as a demand list.

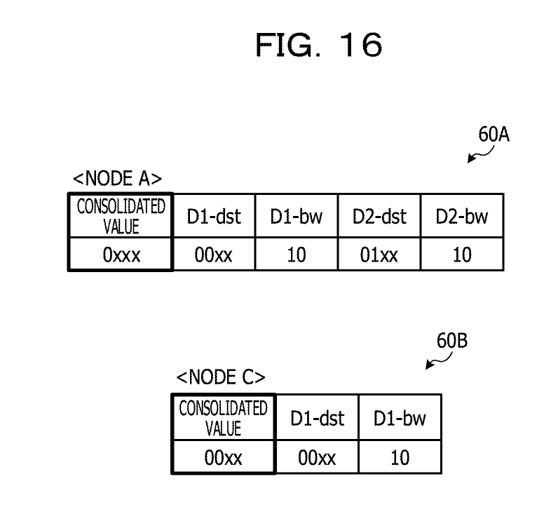

FIG. 16 is a diagram illustrating one example of a packet header according to the example 2. In order to simplify a description, this example only illustrates a destination and bandwidth of a packet header. For example, demand information 31 stores the demand illustrated in FIG. 5. In this case, the generation unit 42 generates a packet 60A that consolidates two demands with a node A as a transmission source. For example, the generation unit 42 generates a packet 60A which includes a destination address “0xxx” as a consolidated type demand header, as well as a destination “00xx”, a bandwidth “10” Mbps, a destination “01xx”, and a bandwidth “10” Mbps as a demand list. The generation unit 42 generates a packet 60B from one demand with a node C as a transmission source. For example, the generation unit 42 generates a packet 60B which includes a destination address “0xxx” as a consolidated type demand header, as well as a destination “00xx” and a bandwidth “10” Mbps as a demand list.

similar to the example 1, the generation unit 42 generates an undemanded packet that does not correspond to any demand stored in the demand information 31.

The calculation unit 43 is configured to calculate a transfer route of each packet generated by the generation unit 42, based on a routing table 32. Similar to the example 1, the calculation unit 43 calculates a transfer route for a packet that does not consolidate a plurality of demands.

On the one hand, in case of the a packet that consolidates a plurality of demands, for each node that receives a packet, the calculation unit 43 sequentially compares a consolidated type demand header of the received packet with each entry information in a routing table 32 of the node to search for corresponding entry information. For example, the calculation unit 43 sequentially reads entry information from the routing table 32. Then, the calculation unit 43 performs bit operation of the consolidated destination address of the packet and the destination address of the read bit entry information. Now, the consolidated destination address is a logical sum of the destination addresses of the demands. Thus, if a destination address of any demand corresponds to entry information, so does the consolidated destination address.

The calculation unit 43 determines whether or not an operation result includes empty. Since the destination address of the packet does not correspond to the destination address of the entry information when the operation result includes empty, the calculation unit 43 makes a comparison with next entry information. Thus, the calculation unit 43 first uses the consolidated destination address to search for the corresponding entry information. With this, the calculation unit 43 may search for the corresponding entry information more promptly than the case in which it is individually searched whether each destination address in a demand list corresponds to entry information.

When the operation result does not include empty, the calculation unit 43 compares each destination address in the demand list with a destination address of entry information to determine a corresponding destination address. For example, the calculation unit 43 performs a bit operation on each destination address in the demand list with a destination address of each entry information and determines a determination address for which an operation result does not include empty.

The calculation unit 43 determines from entry information an output destination corresponding to a destination address of each demand in the demand list. Then, for each output destination, the calculation unit 43 rewrites a header, leaves only a related demand, and outputs a packet to an output destination specified by entry information. For example, for each output destination, the calculation unit 43 generates a packet which includes a consolidated type demand header that consolidates a transmission source address and a destination address of each demand for which an output destination is same, as well as the transmission source address, the destination address, and bandwidth information of each demand as a demand list, and outputs the packet to an output destination. For each node, the calculation unit 43 sequentially repeats the process described above and calculates a transfer route.

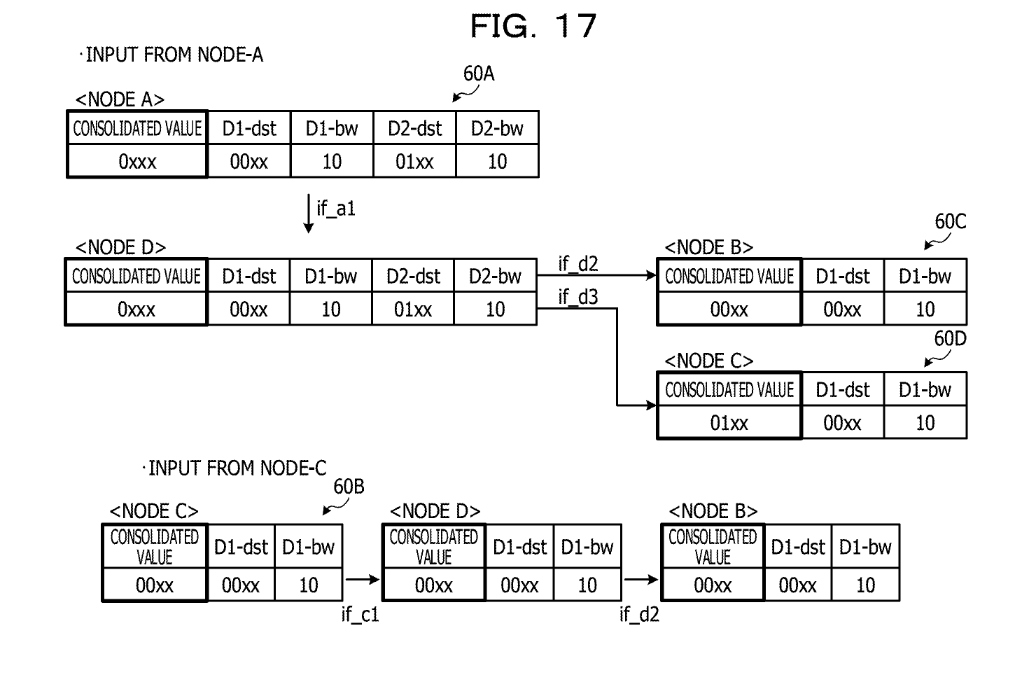

FIG. 17 is a diagram illustrating one example of a result of calculation of a transfer route. FIG. 17 illustrates a result of calculation of a transfer route of packet 60A, 60B. The packet 60A is inputted from the node A and transferred to the node D where packets 60C, 60D are generated for each of the node B and the node C which are an output destination, and respectively transferred. On the one hand, the packet 60B is inputted from the node C and transferred to the node D and the node B. A transfer route for each demand is determined from a transmission source address and a destination address of each demand that is included in a demand list of a header of a packet that is transferred to the edge node.

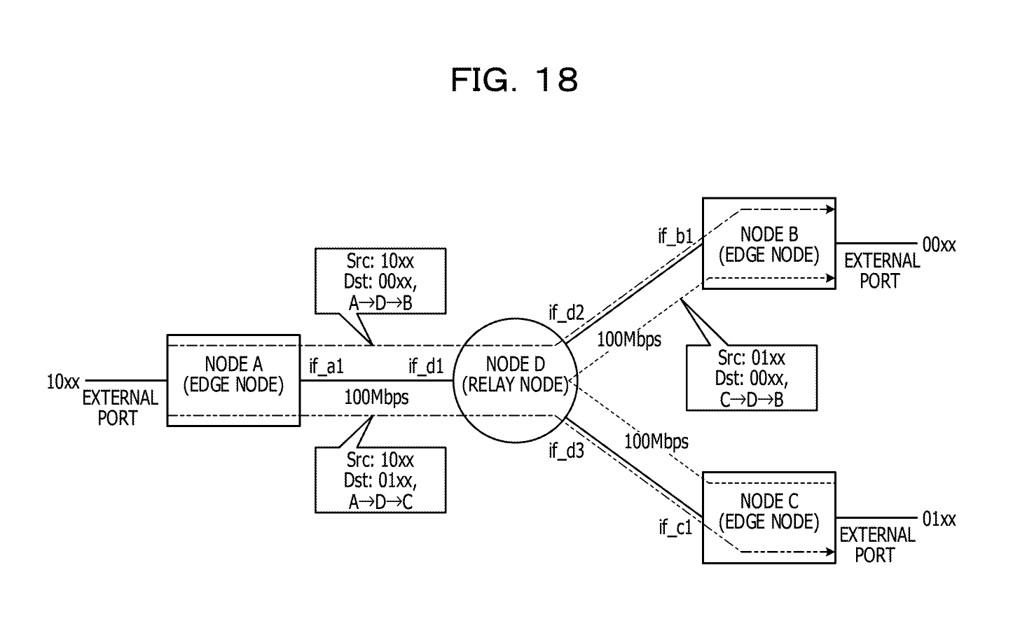

FIG. 18 is a diagram illustrating one example of transfer routes. As illustrated in FIG. 18, a transfer route of a demand with Src (transmission source):10XX and Dst (destination):00XX is determined to be the node A, the node D, and the node B. A transfer route of a demand with Src:10XX and Dst:01XX is determined to be the node A, the node D, and the node C. A transfer route of a demand with Src: 01XX and Dst:01XX is determined to be the node C, the node D, and the node B.

As such, when a consolidated type demand header that consolidates a plurality of demands and a demand list are added to a packet, the calculation unit 43 may collectively calculate a transfer route corresponding to the plurality of demands. This allows the calculation unit 43 to calculate a transfer route corresponding to each demand more promptly than a case in which transfer route is calculated from a packet for each demand.

The route verification unit 44 verifies consistency with a transfer route of a packet calculated by the calculation unit and a communication route of a demand. The route verification unit 44 verifies whether or not a loop occurs on a transfer route.

Every time a packet is transferred between nodes, the bandwidth verification unit 45 accumulates a total of bandwidth value of each demand of the transferred packet, in an area of recording bandwidth in the link bandwidth management table 33 for a link of nodes between which the packet is transferred. As illustrated in FIG. 12, this allows a total of bandwidths to be recorded for each link, even when transfer routes corresponding to a plurality of demands are collectively calculated. The bandwidth verification unit 45 determines whether a total bandwidth recorded for each link is equal to or lower than a value of physical link speed.

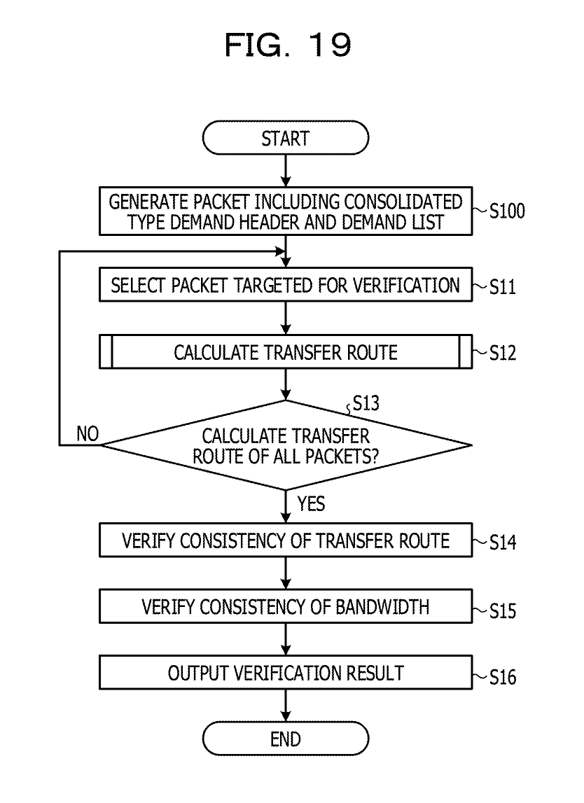

Flow of a verification process in which a routing table verification device 10 according to the example 2 verifies a routing table is described. FIG. 19 is a flow chart illustrating one example of a verification process procedure according to the example 2. Any part which is same as the above-described verification process according to the example 1 is assigned a same symbol and a description the part is omitted.

As illustrated in FIG. 19, for demands for which a transmission source is a same node, the generation unit 42 generates a packet with a header that consolidates the demands (S100). For example, for demands for which a transmission source is a same node, the generation unit 42 generates a packet which includes a consolidated type demand header that consolidates the transmission source addresses and the destination addresses of the demands, as well as the transmission source addresses, the destination addresses, and bandwidth information of the demands as a demand list.

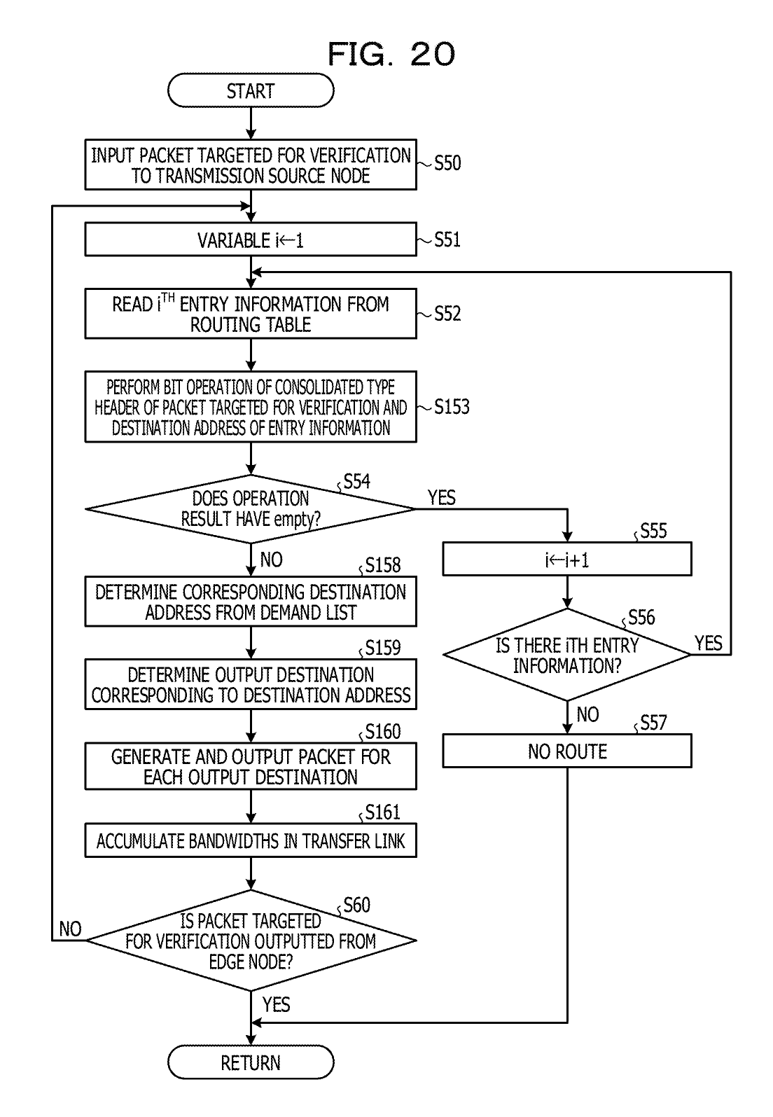

FIG. 20 is a flow chart illustrating one example of a transfer route calculation process procedure according to the example 2. Any part which is same as the above-described transfer route calculation process according to the example 1 is assigned a same symbol and a description the part is omitted.

As illustrated in FIG. 20, the calculation unit 43 performs a bit operation with a consolidated demand header of a packet targeted for verification and a destination address of read entry information (S153).

Then, when an operation result does not include empty (S54 negative), the calculation unit 43 compares each destination address in the demand list with a destination address of entry information and determines a corresponding destination address (S158). The calculation unit 43 determines from the entry information an output destination corresponding to a destination address of each demand in the demand list (S159). For each output destination, the calculation unit 43 generates a packet which includes a consolidated type demand header that consolidates a transmission source address and a destination address of each demand for which an output destination is same, as well as the transmission source address, the destination address, and bandwidth information of each demand as a demand list, and outputs the packet to the output destination (S160).

The bandwidth verification unit 45 accumulates a total of a bandwidth value of each demand of a transferred packet, in an area of recording bandwidth in the link bandwidth management table 33 for a link of nodes between which the packet is transferred (S161).

As described above, the routing table verification device 10 according to this example generates a packet including a transmission source address, a destination address, and bandwidth information that correspond to a communication route and a bandwidth of each demand. For each node, the routing table verification device 10 specifies a transfer destination corresponding to the transmission destination address of each demand included in the packet, based on a routing table of each node. For each transfer destination, the routing table verification device 10 transfers a packet which includes the transfer destination, as well as the transmission source address, the destination address, and bandwidth information of the specified demand and calculates a transfer route. For each link between nodes, the routing table verification device 10 sums up bandwidths included in packets that pass through a link and verifies consistency with a bandwidth amount of the link. This allows the routing table verification device 10 to promptly verify a route and a bandwidth of each demand.

### EXAMPLE 3

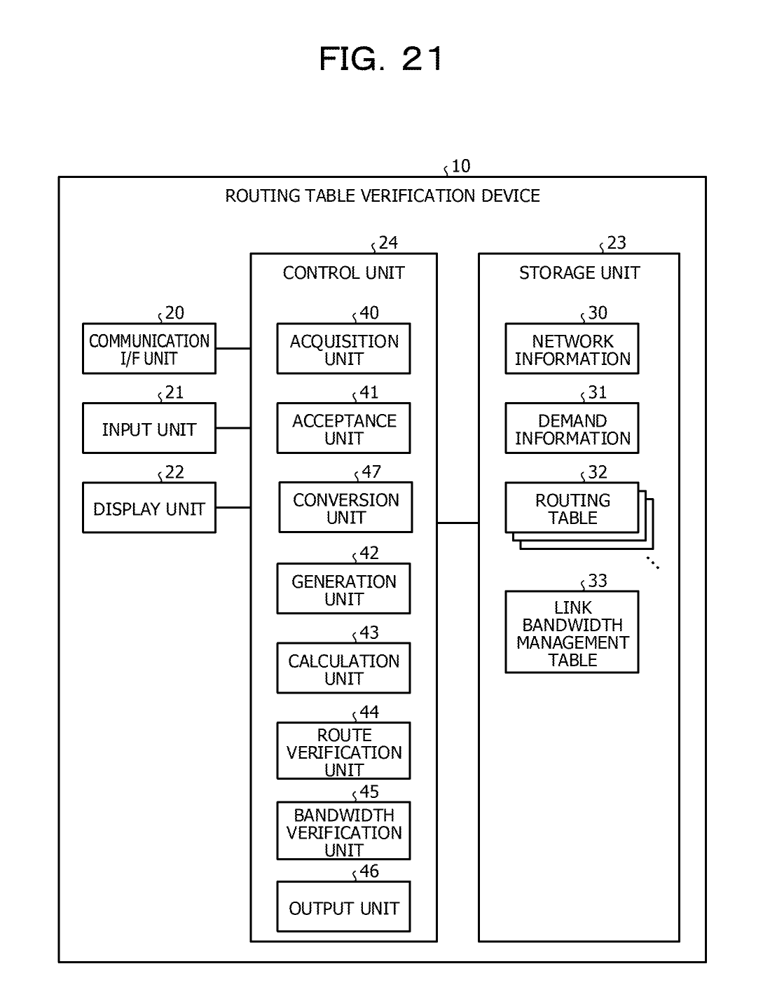

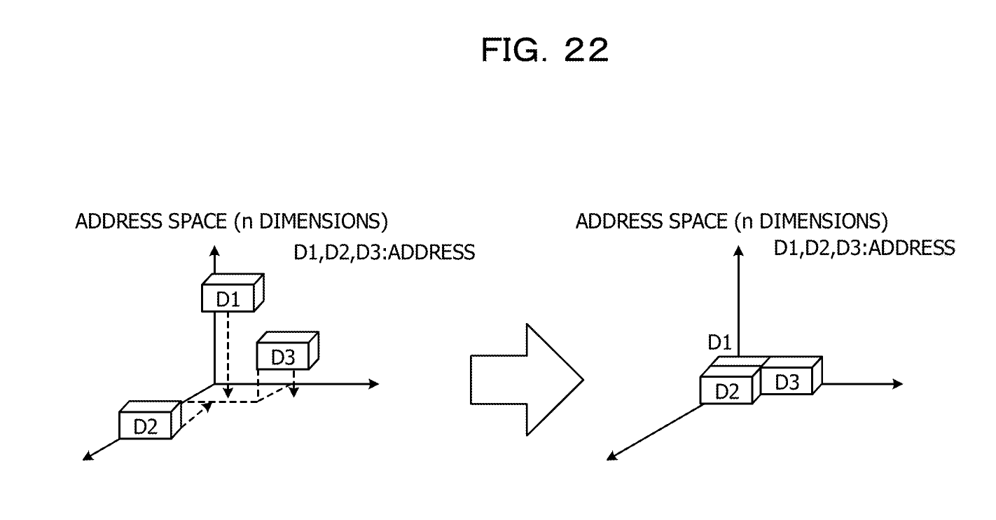

An example 3 is described hereinafter. Since a configuration of a system 1 according to the example 3 is similar to the example 1 illustrated in FIG. 2 and he example 2, a description is omitted. A configuration of a routing table verification device 10 according to this example is described. FIG. 21 is a diagram illustrating one example of a functional configuration of a routing table verification device. Some of the configuration of the routing table verification device 10 according to the example 3 is identical to the example 1 illustrated in FIGS. 2 and 3 and the example 2. Thus, an identical part is assigned with an identical symbol, and different parts are mainly described.

A control unit 24 of the routing table verification device 10 according to the example 3 further has a conversion unit 47.

A generation unit 42 generates a packet including a transmission source address, a destination address, and bandwidth information which correspond to a communication route and a bandwidth, based on each demand stored in the demand information 31. The generation unit 42 generates an undemanded packet that does not correspond to any demand stored in the demand information 31. For example, the generation unit 42 generates an undemanded packet having as an address a complement set of a sum of addresses of a communication route allocation of which is requested by a demand. Both a transmission source address and a destination address may be used for an address of a communication route of a demand. Only either the transmission source address or the destination address may be used for the address of the communication route. For example, the generation unit 42 determines a plurality of addresses that represent a range of addresses which is a complement set of a sum of addresses, with a transmission source address and a destination address as an address of a communication route. Some of a plurality of addresses which are a complement set may overlap in a range. Then, the generation unit 42 generates a plurality of undemanded packets, each having the determined address as an address. For example, the generation unit 42 generates an undemanded packet having a range of a transmission source address and a determination address of the determined address as a transmission source address and a destination address.

When the addresses of demands stored in the demand information 31 are arranged in dispersed address spaces (header spaces), there is a large number of addresses that each represent a range of addresses of a complement set of a sum of addresses of demands. An undemanded packet is generated for each address that represents a range of addresses of a complement set. Thus, when there are a large number of addresses that represent a range of addresses, there are a large number of undemanded packets as well. In verification for undemand, a transfer route is calculated for each undemanded packet. Thus, a large number of undemanded packets lead to an increase in verification time taken for verification outside the demands. In the following, a description is given with an example where each of a transmission source address and a destination address is 3-bit, and an address of a demand is represented by 6 bits of “a transmission source address of 3 bits and a destination address of 3 bits”. Each of the transmission source address and the destination address is not limited to 3 bits. For example, if there are two demand addresses of “000 XXX” and “111 XXX”, there are four addresses “X01 XXX”, “X10 XXX”, “011 XXX”, and “100 XXX” to represent addresses other than the addresses of demands. “X” is a wildcard which may be any of “0” and “1”. The wildcard X may also be referred to “a don't care bit”. The four addresses other than the addresses of demands may not be merged. Ranges of the addresses other than the addresses of demands may not be expressed by a number smaller of addresses.

In normal operation of a network, any undemanded packet is not relayed in the network. However, an undemanded packet is not only dropped in an edge node inputted in the network, and may be dropped in a relay node within the network. In this manner, when an undemanded packet is dropped in a relay node, time taken for verification outside the demands increases. The verification outside the demands is performed by inputting undemanded packets from all edge nodes. Thus, if the number of external ports increases, the time taken for the verification outside the demands increases. Hence, the routing table verification device 10 according to the example 3 performs address conversion so that ranges of addresses other than the addresses of demands, which is a complement set of a sum of the addresses of demands, may be expressed with a small number of addresses.

A conversion unit 47 is configured to perform various conversion processes. For example, when a plurality of demands are stored in demand information 31, the conversion unit 47 converts the addresses of the communication routes of the demands such that the addresses are arranged in adjacent address spaces. For example, the conversion unit 47 arranges addresses having the same number of wildcards X in the adjacent address spaces, and determines whether or not there are addresses continuous in the address space. If there are addresses of conversion destinations, the conversion unit 47 converts the addresses of the demands to the addresses of conversion destinations.

FIG. 22 is a diagram schematically illustrating address conversion. FIG. 22 illustrates a range indicated by each address in an n-dimensional address space in which predetermined bit units of the address are set as respective axes. FIG. 22 schematically illustrates the address spaces in a three-dimensional manner. An address space may be a space with each bit of an address as one axis. On the left side of FIG. 22, are illustrated areas D1 to D3 of the address spaces, corresponding to addresses D1 to D3 of three demands. On the left side of FIG. 22, the areas D1 to D1 stay aloof. For example, the conversion unit 47 performs conversion so that the areas D1 to D3 of each address are contiguous. On the right side of FIG. 22 is illustrated one example of a result of the conversion so that the areas D1 to D3 of each address are contiguous.

The conversion unit 47 performs conversion through parallel movement and bit shifting of addresses of demands, so that the addresses of demands are moved to adjacent spaces. For example, out of empty addresses that do not correspond to any demand address, the conversion unit 47 determines addresses, a sum of which has a large number of bits represented by the wildcard X. For example, for addresses of a plurality of demands having the same number of wildcards X, the conversion unit 47 determines addresses of conversion destinations such that the addresses may have the wildcards X at the same positions, and may be adjacent while differing only by one bit excluding the wildcards X. The conversion unit 47 converts the address of each demand to the address of the conversion destination. When a sum of addresses is determined, the addresses which differ only by one bit excluding the wildcards X may be expressed in one address with the different one bit expressed by the wildcard X. When some or all addresses includes a large number of bits represented by the wildcard X, the conversion unit 47 does not have to convert the some or all addresses. Thus, the conversion unit 47 converts the addresses of demands to the adjacent spaces so that there are a large number of bits represented by the wildcard X.

One example of parallel movement is illustrated. For example, when the number and position of X are same for two addresses of demands, the conversion unit 47 moves one address to an adjacent address space of the other address. With this, the address spaces of the two addresses after conversion may be expressed in one address. The conversion unit 47 performs movement when an area of movement destination is not an area of an address of other demand.

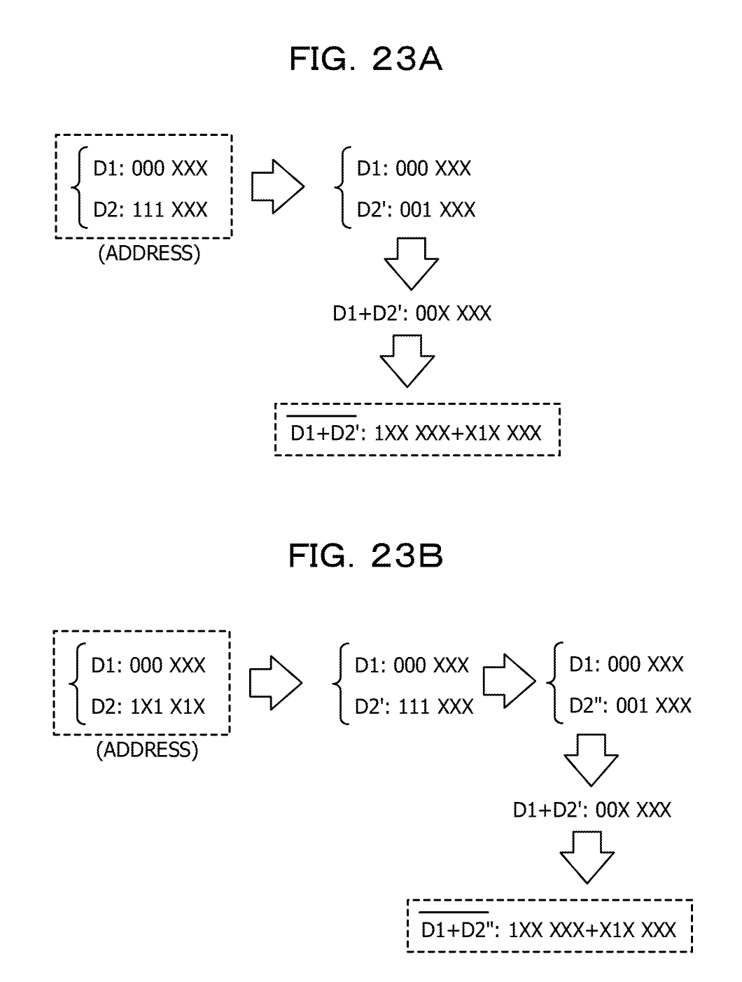

FIG. 23A is a diagram illustrating one example of parallel movement. In the example of FIG. 23A are illustrated “D1:000 XXX” and “D2:111 XXX” as addresses D1 and D2 of two demands. In this case, the conversion unit 47 moves in parallel the address D2 by the address space and coverts it to an address D2′ so that the address D2′ is adjacent to the address D1. For example, the conversion unit 47 converts “D2:111 XXX” to “D2′:001 XXX”. A sum of the address D1 and the address D2′ may be expressed as 00X XXX.

Then, one example of bit shifting is illustrated. For example, when addresses of two demands have the same number of X but different positions of X, the conversion unit 47 shifts a bit of one address so that the position of X of the one address matches that of the other address, and further moves in parallel the one address. Also in this case, the address spaces of the two addresses after the conversion may be represented by one address. The conversion unit 47 performs shifting or parallel movement if an area of final movement destination is not an area of an address of another demand.

FIG. 23B is a diagram illustrating one example of bit shifting. In the example of FIG. 23B, “D1:000 XXX” and “D2:1X1 X1X” are illustrated as addresses D1, D2 of two demands. In this case, the conversion unit 47 shifts a bit of the address D2 by the address space, and converts the address D2 to address D2′ so that the X position is the same as in the address D1. For example, for “D2:1X1 X1X”, the conversion unit 47 changes X at the fourth bit from the head with 1 at the fifth bit from the head, and replaces X at the second bit from the head with the right next bit till X reaches the position of the fourth bit. Instead, for “D2:1X1 X1X”, the conversion unit 47 may exchange X at the second bit from the head with 1 at the fifth bit to make the position of X same. Then, the conversion unit 47 moves in parallel the address D2′ in the address space and converts the address D2′ to an address D2″ so that the address D2″ is adjacent to the address D1. For example, the conversion unit converts “D2′:111 XXX” to “D2”:001 XXX″. A sum of the address D1 and the address D2″ may be expressed by “00X XXX”.

The conversion unit 47 converts an address in the routing table 32 of each node, corresponding to conversion of an address of each demand. For example, when a transmission source address and a destination address of the routing table 32 includes an address converted by a demand, the conversion unit 47 converts the transmission source address and the destination address of the routing table 32 to the address converted by the demand.

The generation unit 42 generates a packet including a transmission source address, a destination address, and bandwidth information corresponding to a communication route and a bandwidth, based on the converted address of each demand. For example, the generation unit 42 generates a packet having, as a transmission source address and a destination address, a transmission source address and a destination address of an address of a sum of the converted address of each demand.

The generation unit 42 generates an undemanded packet that does not correspond to any converted address of each demand. For example, the generation unit 42 generates an undemanded packet having an address that is an address of a complement set of a sum of the addresses of the demands. For example, the generation unit 42 generates a plurality of undemanded packets that cover a range of transmission addresses and destination addresses of the address which is a complement set of the addresses of the demands.

Here, there are some cases in which even if the addresses of demands are made adjacent, a sum of the addresses of demands is represented by a plurality of addresses. For example, when the number of addresses after parallel movement and bit shifting is not 2ⁿ (n is a natural number of 1 or higher), a sum of addresses is represented by a plurality of addresses. As such, if the sum of addresses is the plurality of addresses, the number of expressions increases when a complement set of a sum is determined.

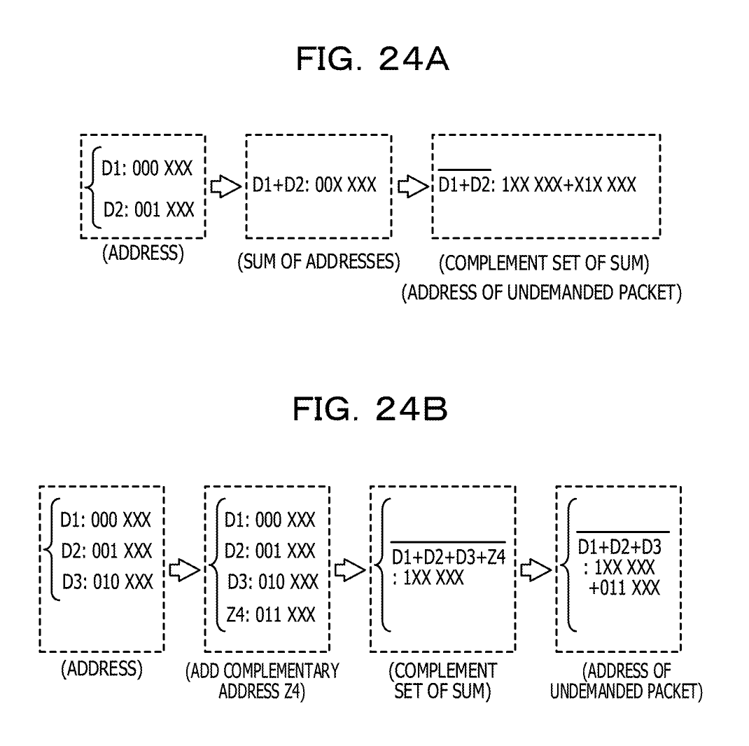

For example, when the number of addresses is 2ⁿ, a sum of the addresses may be expressed in one expression form. FIG. 24A is a diagram illustrating one example of a method of determining an address of an undemanded packet. In the example of FIG. 24A, “D1:000 XXX” and “D2:001 XXX” are illustrated as addresses D1, D2 of two demands. A sum of these addresses D1, D2 (D1+D2) may be expressed by one address “00X XXX”. A complement set of these addresses D1, D2 is “1XX XXX”+“X1X XXX”.

On the other hand, when the number of addresses is not 2ⁿ, the expression form of a sum of addresses is by a plurality of addresses. FIG. 24B is a diagram illustrating one example of a method of determining an address of an undemanded packet. In the example of FIG. 24B, “D1:000 XXX”, “D2:001 XXX”, and “D3:010 XXX” are illustrated as addresses D1, D2, D3 of three demands. A sum of these addresses D1, D2, D3 (D1+D2+D3) are “00X XXX” and “010 XXX”.

Then, the generation unit 42 determines a complementary address that complements the addresses of the demands such that an address indicating a sum of the addresses of the demands is one address when the wildcard X is used. For example, in the case of FIG. 24B, the generation unit 24 determines “Z4:011 XXX” as a complementary address. A sum of the addresses D1, D2, D3, and Z4 (D1+D2+D3+Z4) may be expressed by one address “0XX XXX”. A complement set of the sum of the addresses D1, D2, D3, Z4 is “1XX XXX”.

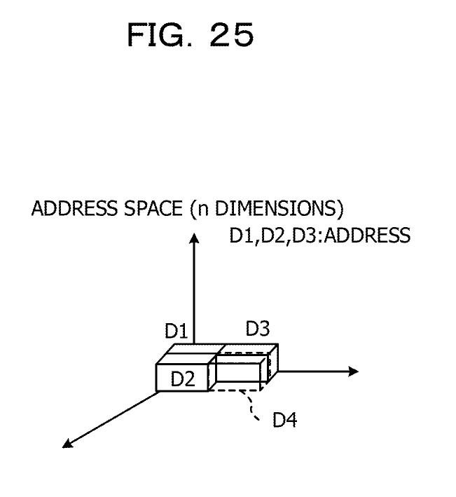

FIG. 25 is a diagram schematically illustrating an address and a complementary address in address spaces. FIG. 25 illustrates areas D1 to D3, Z4 in the address spaces corresponding to the addresses D1 to D3 and the complementary address Z4. An area of a sum of the areas D1 to D3 has irregularities in the address spaces and may not be expressed by one expression form. The generation unit 42 determines a complementary address so that these irregularities are filled and the address space is an area constituted by two planes opposed across each of the axes in the address space. For example, in the example of FIG. 25, the generation unit 42 determines a complementary address Z4 so that the areas D1 to D3, Z4 are a cuboid consisting of two planes opposed across each axis.

When the number of addresses of demands is 2ⁿ, the generation unit 42 generates an undemanded packet having an address that is a complement set of a sum of the converted addresses of the demands. For example, the generation unit 42 generates a plurality of undemanded packets covering a range of a transmission source address and a destination address of an address, which is a complement set of the demands. In the case of FIG. 24A, the generation unit 42 generates two undemanded packets having a transmission source address and a destination address of “1XX XXX” and “X1X XXX”.

On the other hand, when the number of addresses of demands is not 2ⁿ, the generation unit 42 determines a complementary address that complements the converted addresses of the demands such that an address indicating a sum of the converted addresses of the demands is one address when the wildcard X is used. Then, the generation unit 42 generates an undemanded packet having, as addresses, an address that is a complement set of a sum of the complementary address and the addresses of the demands, and the complementary address. In the case of FIG. 24B, the generation unit 42 determines a complementary address Z4 for the addresses D1 to D3. Then, the generation unit 42 generates two undemanded packets having, as a transmission source address and a destination address, “1XX XXX” which is a complement set of a sum of the addresses of the demands, and “011 XXX” which is a complementary address Z4.

The calculation unit 43 calculates a transfer route of each packet generated by the generation unit 42, based on the routing table 32 for which the address is converted by the conversion unit 47. For example, the calculation unit 43 inputs a packet corresponding to a demand to the network 14 from a transmission source node, and calculates a transfer route of the packet according to the routing table 32 of each node. The calculation unit 43 inputs an undemanded packet to the network 14 from each edge node. Then, the calculation unit 43 calculates a transfer route of the packet according to the routing table 32 of each node.

A route verification unit 44 verifies consistency of a transfer route of a packet calculated by the calculation unit 43 and a communication route of an address-converted demand. For example, the route verification unit 44 verifies consistency with the communication route of the address-converted demand from a transmission address and a destination address of a packet that reaches a final node.

The route verification unit 44 verifies that there is no communication route for an undemanded packet, as consistency of the communication route. For example, the route verification unit 44 verifies whether an undemanded packet is dropped without being transferred in any node of the network 14.

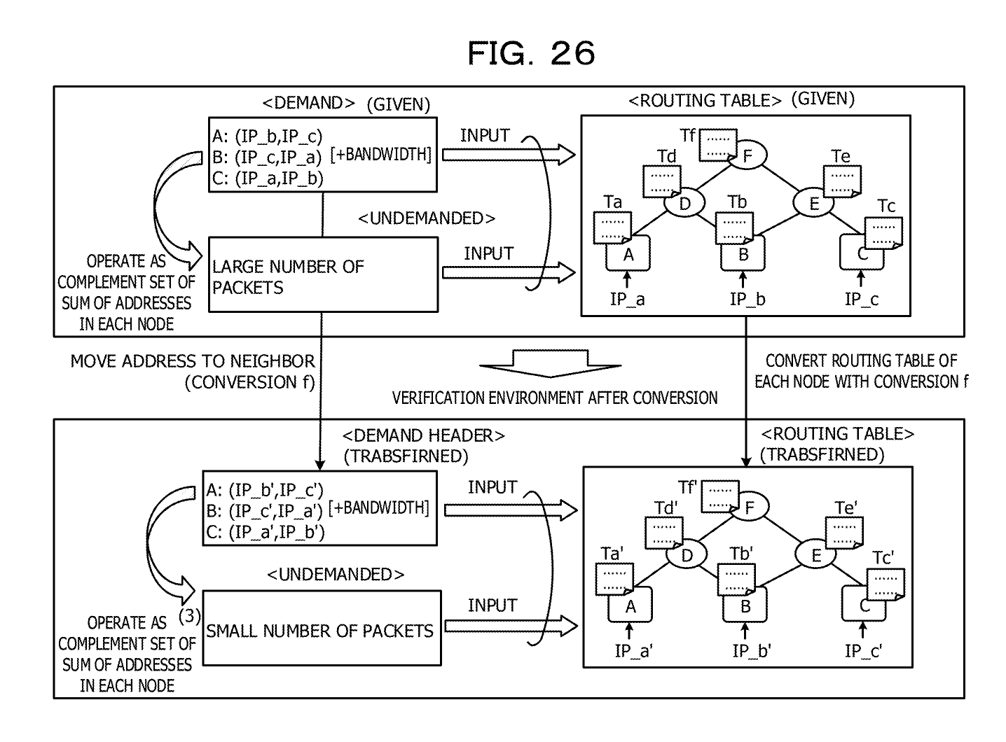

FIG. 26 is a diagram schematically illustrating conversion of verification environment. In the upper part of FIG. 26 is schematically illustrated the verification environment before an address is converted. In the example of 26, a network of nodes A to F is illustrated. The nodes A to C are edge nodes. The node A has an IP address “IP_a”. The node B has an IP address “IP_b”. The node C has an IP address “IP_c”. FIG. 26 illustrates three demand A to C. The demand A has a transmission address of IP_b and a destination address of IP_c. The demand B has a transmission address of IP_c and a destination address of IP_a. The demand C has a transmission address of IP_a and a destination address of IP_b. in network designing, a route is designed according to a demand. For example, in network designing, routing tables Ta to Tf for the nodes A to F are generated according to demands A to C. In the system 1 according to this example, before the routing tables Ta to Tf are applied to an actual network, software verifies validity of the generated routing tables Ta to Tf. For example, based on the demands A to C, the routing table verification device 10 generates a packet including a transmission source address, a destination address, and bandwidth information corresponding to a transmission route and a bandwidth and verifies a communication route of the demand. The routing table verification device 10 generates an undemanded packet of an address that is a complement set of addresses of the communication routes of the demands A to C, and verifies a communication route outside the demands. However, if the addresses of demands are arranged in dispersed address spaces, a large number of undemanded packets are generated.

Thus, in the routing table verification device 10 according to this example, the conversion unit 47 converts the addresses of the demands so that they are adjacent. In the example of FIG. 26, the IP address “IP-a” is converted to an IP address “IP-a′”, the IP address “IP-b” is converted to an IP address “IP-b′”, and the IP address “IP-c” is converted to an IP address “IP-c′”. In the example of FIG. 26, this address conversion is depicted as conversion f.

The generation unit 42 generates a packet including a transmission source address, a destination address, and bandwidth information corresponding to a communication route and a bandwidth, based on the converted address of each demand. For example, the generation unit 42 generates a packet having, as a transmission source address and a destination address, a transmission source address and a destination address of an address of a sum of the converted address of each demand.

The conversion unit 47 converts an address of the routing table 32 of each node, corresponding to the conversion f of the address of each address. In the example of FIG. 26, the routing tables Ta to Tf of the nodes A to F are converted to routing tables TA′ to Tf′. After performing such conversion f, the routing table verification device 10 verifies in the verification environment after being converted.

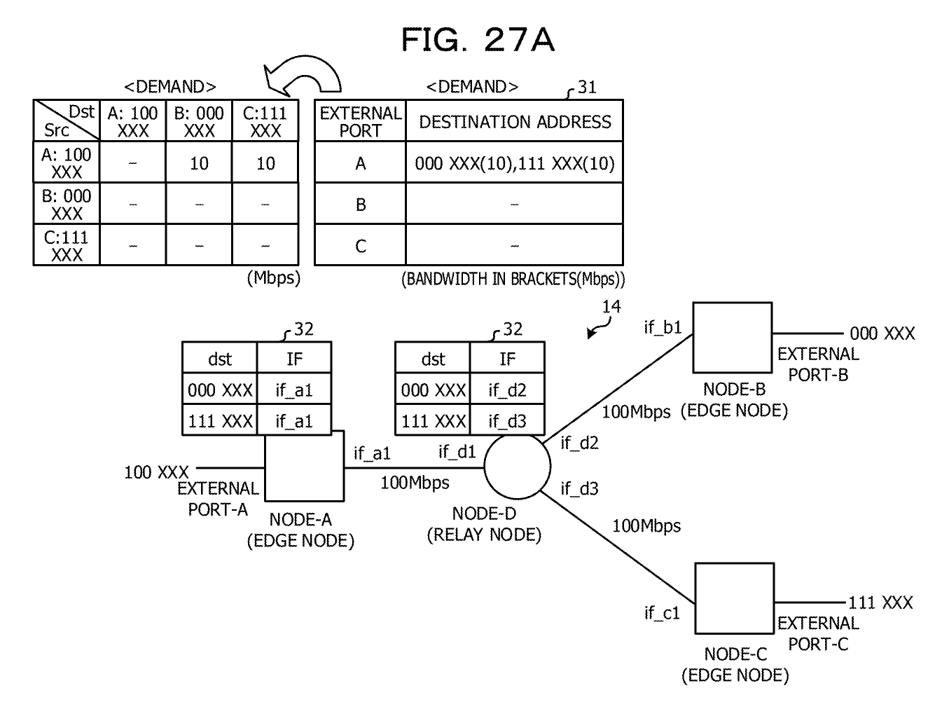

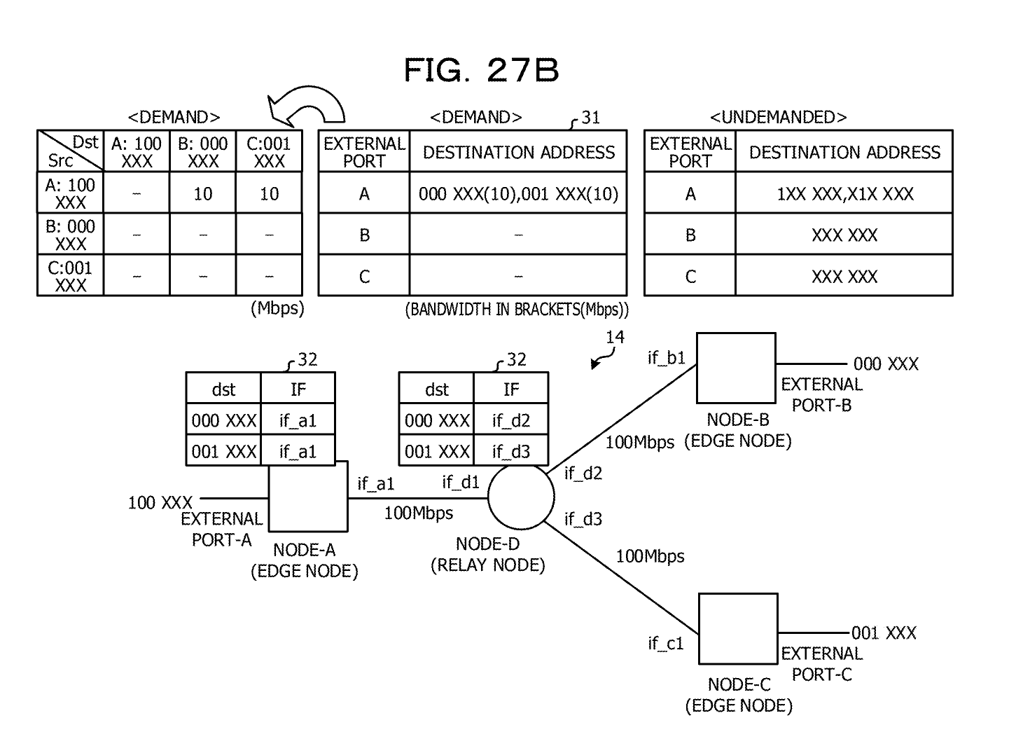

Verification of a routing table is described hereinafter by a specific example. In the following, a description is given with an example where verification of a destination address is performed with an address being a destination address only. FIG. 27A is a diagram illustrating one example of the verification environment before conversion. FIG. 27A illustrates one example of a network 14 that performs verification. The network 14 has a node A, a node B, a node C, and a node D, and the node A, the node B, and the node C are connected by way of the node D. The node A, the node B, and the node C are an edge node configured to communicate with the outside. The node D is a relay node configured to relay data from the edge node.

The node A has an external port A having an address of “100 XXX” and an interface if_a1 and is connected with the node D by way of the interface if_a1. The node B has an external port B having an address of “000 XXX” and an interface if_b1 and is connected with the node D by way of the interface if_b1. The node C has an external port C having an address of “111 XXX” and an interface if_c1 and is connected with the node D by way of the interface if_c1. The node D has interfaces if_d1, if_d2, if_d3, and is connected with the node A by way of the interface if_d1, the node B by way of the interface if_d2, and the node C by way of the interface if_d3. In this example, in order to simplify a description, an address is represented by 6 bits of “100 XXX”, for example. “X” in an address represents a wildcard that may substitute any applicable address bit, irrespective of whether the address bit is “0” or “1”.

FIG. 27A illustrates one example of the demand information 31. In the example of FIG. 27A are illustrated 6-bit destination addresses which correspond to external ports and are a destination of a communication route allocation of which is requested, and bandwidths allocation of which are requested are indicated in brackets. In the example of FIG. 27A, to the left of the demand information 31, bandwidths that correspond to a transmission route and a transmission destination of the communication route and are desirably reserved in the communication route are listed in a matrix.

FIG. 27A illustrates one example of the routing table 32 of the node A, node D. In this example, in order to simplify a description, only output destinations corresponding to destinations are listed as entry information in the routing table 32. In the example of FIG. 27A, for the node A, an output destination of a packet addressed to “000 XXX” and “111 XXX” is the interface if_a1. For the node D, an output destination of a packet addressed to “000 XXX” is the interface if_d2, and an output destination of a packet addressed to “111 XXX” is the interface if_d3.

In the example of FIG. 27A, there are two demands having destination addresses of “000 XXX” and “111 XXX” in the external port A, and no demand is present in the external ports B, C. Then, the routing table verification device 10 converts the destination addresses of “000 XXX” and “111 XXX” of the two demands in the external port A to adjacent spaces. Since this conversion is similar to FIG. 23A, the destination addresses are converted to two addresses of “000 XXX” and “001 XXX”. With this conversion as conversion f1, the conversion f1 may be expressed as follows for the destination address.

f1:(111 XXX→001 XXX)

The routing table verification device 10 applies the conversion f1 to the routing table of each node to convert the address. FIG. 27B is a diagram illustrating one example of the verification environment before conversion. Through application of the conversion f1 to the routing table of each node, for example, for the node A, the output destination of the packet addressed to “001 XXX” is converted to the interface if_a1. For the node D, the output destination of the packet addressed to “001 XXX” is converted to the interface if_d3.

The routing table verification device 10 generates an undemanded packet from an address of a demand. As illustrated in FIG. 23A, since the sum of “000 XXX” and “001 XXX” is “00X XXX”, the routing table verification device 10 two undemanded packets having “1XX XXX” and “X1X XXX” as a destination address.

Now, when there are two addresses of demands of “00X XXX” and “111 XXX”, four addresses of “X01 XXX”, “X10 XXX”, “011 XXX”, and “100 XXX” represent the addresses other than the addresses of the demands without address conversion. The routing table verification device 10 according to this example may reduce the undemanded packet addresses to the two addresses of “1XX XXX” and “X1X XXX” by performing address conversion.

Based on the routing table 32 of each node, the routing table verification device 10 calculates a transfer route when the generated undemanded packet is inputted from the external port A, and verifies from a calculation result whether the undemanded packet is dropped at any node without being transferred.

Since no demand header is present for the external ports B, C, the routing table verification device 10 generates an undemanded packet having as a destination address “XXX XXX” which is a complement set thereof. Based on the routing table 32 of each node, the routing table verification device 10 calculates a transfer route when the generated undemanded packet is inputted from the external ports B, C, respectively. The routing table verification device 10 verifies from a calculation result whether the undemanded packet is dropped at any node without being transferred.

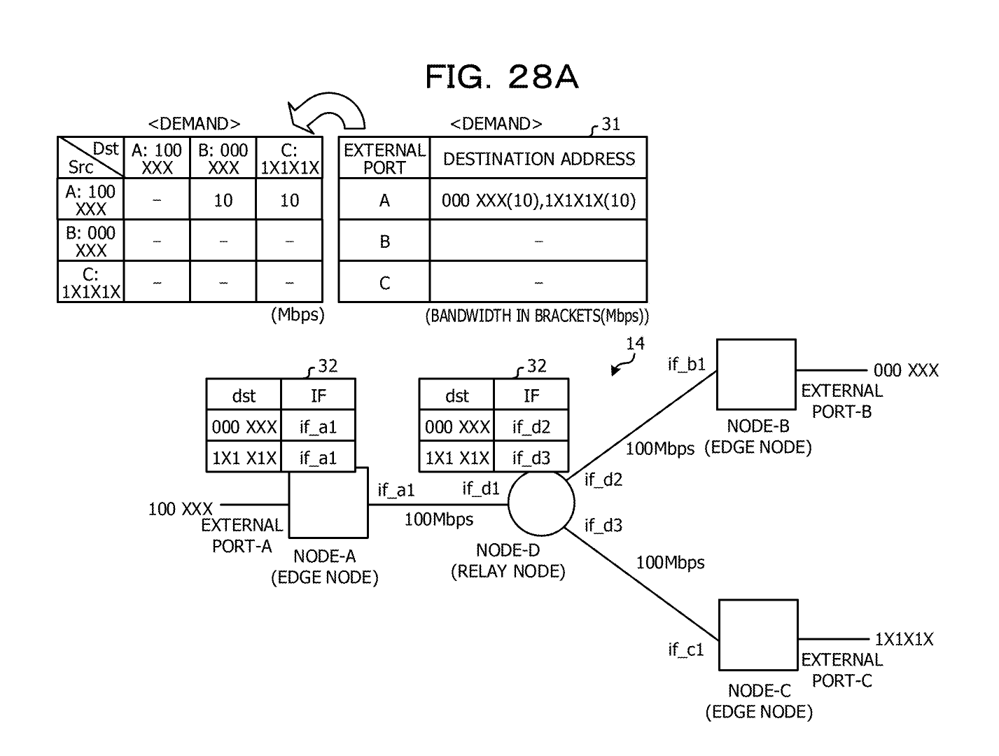

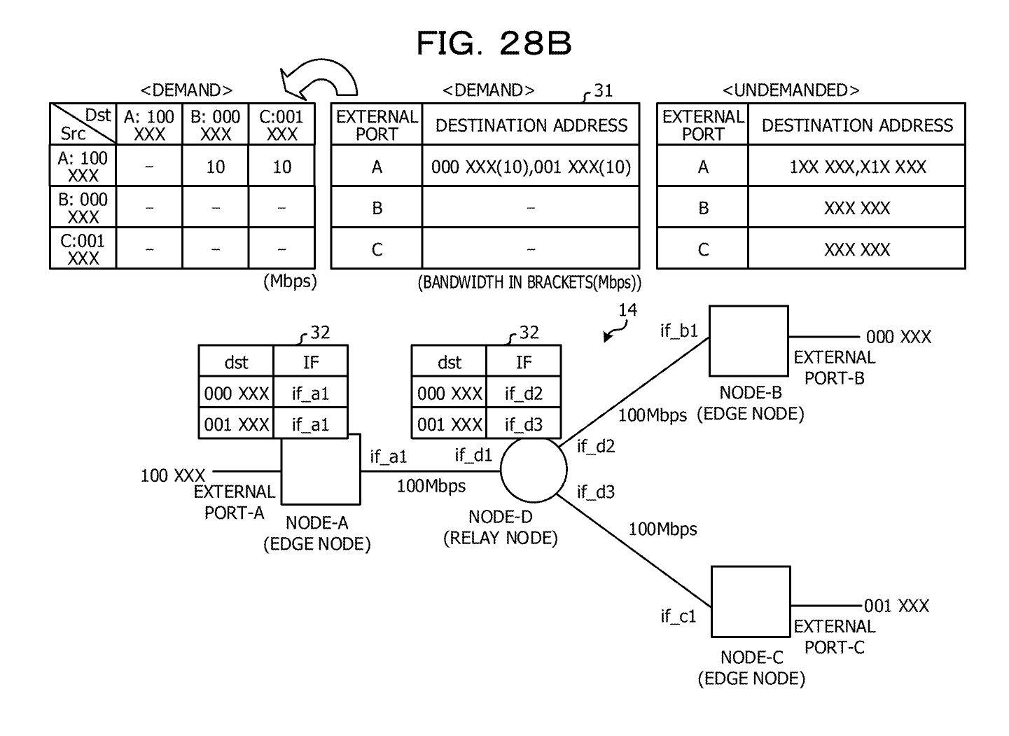

Then, other specific examples are described. FIG. 28A is a diagram illustrating one example of the verification environment before conversion. FIG. 28A illustrates a network 14 which is similar to FIG. 27. FIG. 28A also illustrates one example of the demand information 31, and to the left of the demand information 31, bandwidths that correspond to a transmission route and a transmission destination of a communication route and that are desirably reserved in the communication route are listed in a matrix. Also in this example, in order to simplify a description, only output destinations corresponding to destinations are listed as entry information in the routing table 32. In the example of FIG. 28A, for the node A, an output destination of a packet addressed to “000 XXX” and “1X1 X1X” is the interface if_a1. For the node D, an output destination of a packet addressed to “000 XXX” is the interface if_d2, and an output destination of a packet addressed to “1X1 X1X” is the interface if_d3.

In the example of FIG. 28A, there are two demands having destination addresses of “000 XXX” and “1X1 X1X” in the external port A, and no demand is present in the external ports B, C. Then, the routing table verification device 10 converts the destination addresses of “000 XXX” and “1X1 X1X” of the two demands in the external port A to adjacent spaces. Since this conversion is similar to FIG. 23B, the destination addresses are converted to two addresses of “000 XXX” and “001 XXX”. With this conversion as conversion f2, the conversion f2 may be expressed as follows for the destination address.

f2:(1X1 X1X→001 XXX)

The routing table verification device 10 applies the conversion f2 to the routing table of each node to convert the address. FIG. 28B is a diagram illustrating one example of the verification environment before conversion. Through application of the conversion f2 to the routing table of each node, for example, for the node A, the output destination of the packet addressed to “001 XXX” is converted to the interface if_a1. For the node D, the output destination of the packet addressed to “001 XXX” is converted to the interface if_d3.

The routing table verification device 10 generates an undemanded packet from an address of a demand. As illustrated in FIG. 23B, since the sum of “000 XXX” and “001 XXX” is “00X XXX”, the routing table verification device 10 two undemanded packets having “1XX XXX” and “X1X XXX” as a destination address.

Now, when two addresses of demands are “00X XXX” and “1X1 X1X”, the two addresses are in dispersed address spaces. Thus, a large number of addresses represent the addresses outside the demands without address conversion. The routing table verification device 10 according to this example may reduce the undemanded packet addresses to the two addresses of “1XX XXX” and “X1X XXX” by performing address conversion.

Based on the routing table 32 of each node, the routing table verification device 10 calculates a transfer route when the generated undemanded packet is inputted from the external port A, and verifies from a calculation result whether the undemanded packet is dropped at any node without being transferred.

Since no demand header is present for the external ports B, C, the routing table verification device 10 generates an undemanded packet having as a destination address “XXX XXX” which is a complement set thereof. Based on the routing table 32 of each node, the routing table verification device 10 calculates a transfer route when the generated undemanded packet is inputted from the external ports B, C, respectively. The routing table verification device 10 verifies from a calculation result whether the undemanded packet is dropped at any node without being transferred.

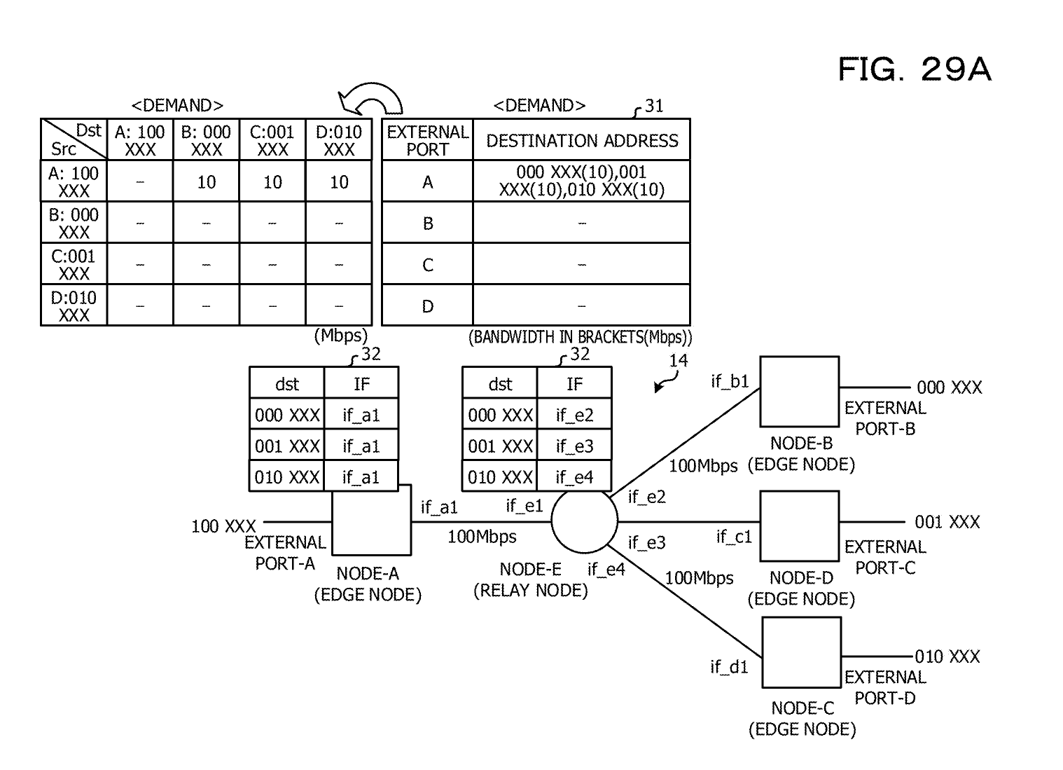

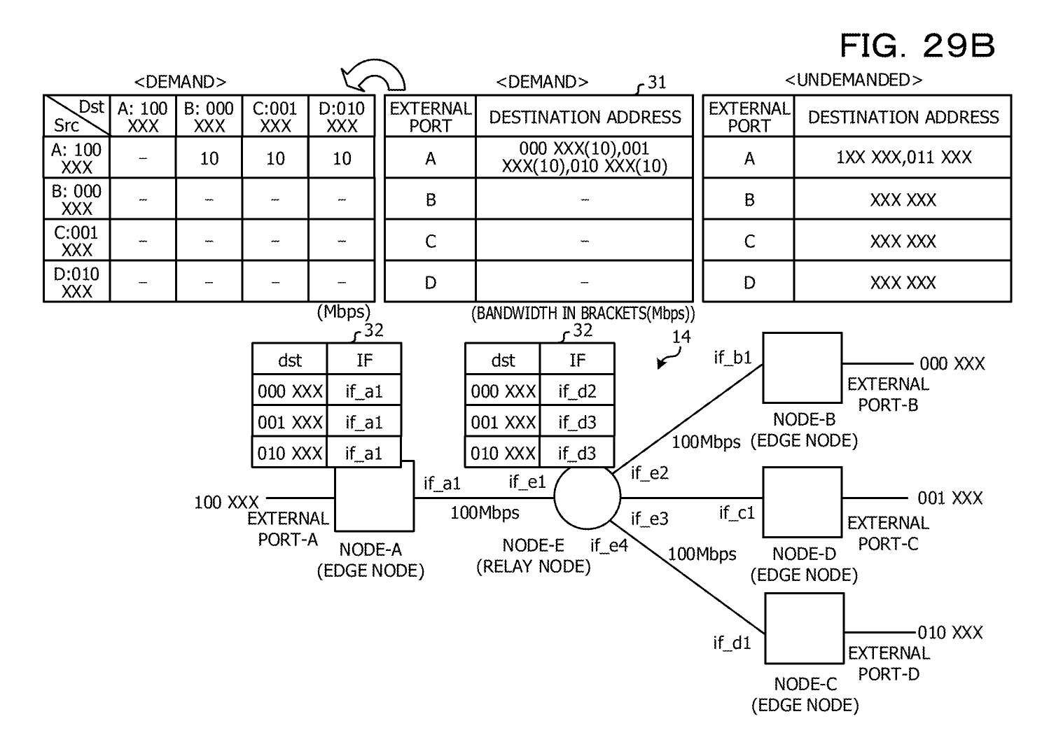

Then, other specific examples are described. FIG. 29A is a diagram illustrating one example of the verification environment before conversion. FIG. 29A illustrates a network 14 that performs verification. The network 4 has a node A, a node B, a node C, a node D, and a node E, and the node A, the node B, the node C, and the node D are connected by way of the node E. The node A, the node B, the node C, and the node D is an edge node configured to communicate with the outside. The node E is a relay node configured to relay data from the edge node.

The node A includes an external port A having an address of “100 XXX” and an interface if_a1 and is connected with the node E by way of the interface if_a1. The node B includes an external port B having an address of “000 XXX” and an interface if_b1 and is connected with the node E by way of the interface if_b1. The node C includes an external port C having an address of “001 XXX” and an interface if_c1 and is connected with the node E by way of the interface if_c1. The node D includes an external port d having an address of “010 XXX” and an interface if_d1, and is connected with the node E by way of the interface if_d1. The node E includes interfaces if_e1, if_e2, if_e3, if_e4. The node E is connected with the node A by way of the interface if_e1, the node B by way of the interface if_e2, the node C by way of the interface if_e3, and the node D by way of the interface if_e4. In this example, in order to simplify a description, an address is represented by 6 bits of “000 XXX”, for example. “X” in an address represents a wildcard that may substitute any applicable address bit, irrespective of whether the address bit is “0” or “1”.

FIG. 29A illustrates one example of the demand information 31. In the example of FIG. 29A are illustrated 6-bit destination addresses which correspond to external ports and are a destination of a communication route allocation of which is requested, and bandwidths allocation of which are requested are indicated in brackets. In the example of FIG. 29A, to the left of the demand information 31, bandwidths that correspond to a transmission route and a transmission destination of the communication route and are desirably reserved in the communication route are listed in a matrix.

FIG. 29A illustrates one example of the routing table 32 of the node A, node E. In this example, in order to simplify a description, only output destinations corresponding to destinations are listed as entry information in the routing table 32. In the example of FIG. 29A, for the node A, an output destination of a packet addressed to “000 XXX”, “001 XXX”, and “010 XXX” is the interface if_a1. For the node E, an output destination of a packet addressed to “000 XXX” is the interface if_e2, an output destination of a packet addressed to “001 XXX” is the interface if_e3, and an output destination of a packet addressed to “010 XXX” is the interface if_e4.

In the example of FIG. 29A, there are three demands having destination addresses of “000 XXX”, “001 XXX”, and “010 XXX” in the external port A, and no demand is present in the external ports B to D. Then, the routing table verification device 10 converts the destination addresses of “000 XXX” “001 XXX”, and “010 XXX” of the three demands in the external port A to adjacent spaces. Since these have already been arranged in the adjacent spaces, no more conversion is desirable, and these directly become addresses after conversion. With the conversion of the header space then as conversion f3, the conversion f3 may be expressed as follows, which means that there is no conversion for the destination address:

f3:(φ→φ)

where φ shall mean an empty set.

The routing table verification device 10 applies the conversion f3 to the routing table of each node to convert the address. FIG. 29B is a diagram illustrating one example of the verification environment before conversion. Since there is no address to be converted by the conversion f3, the routing table of each node illustrated in FIG. 29B is same as FIG. 29A.

The routing table verification device 10 generates an undemanded packet from an address of a demand. As illustrated in FIG. 24B, the routing table verification device 10 generates from “000 XXX” “001 XXX”, and “010 XXX” two undemanded packets having destination addresses of “1xX XXX” and “001 XXX”.

Now, when there are three addresses of demands of “000 XXX” “001 XXX”, and “010 XXX”, the number of addresses that express a sum of each address increases. Thus, the number of addresses is large to represent addresses other than the addresses of the demands without complementation with a complementary address. The routing table verification device 10 according to this example may reduce the undemanded packet addresses to the two addresses of “1XX XXX” and “X1X XXX” by complementing a complementary address.

Based on the routing table 32 of each node, the routing table verification device 10 calculates a transfer route when the generated undemanded packet is inputted from the external port A. Then, the routing table verification device 10 verifies from a calculation result whether the undemanded packet is dropped at any node without being transferred.

Since no demand header is present for the external ports B to D, the routing table verification device 10 generates an undemanded packet having as a destination address “XXX XXX” which is a complement set thereof. Based on the routing table 32 of each node, the routing table verification device 10 calculates a transfer route when the generated undemanded packet is inputted from the external ports B to D, respectively. The routing table verification device 10 verifies from a calculation result whether the undemanded packet is dropped at any node without being transferred.

As such, the routing table verification device 10 may perform verification outside the demands with a small number of undemanded packets. With this, the routing table verification device 10 may control increase in verification time taken for verification outside the demands.

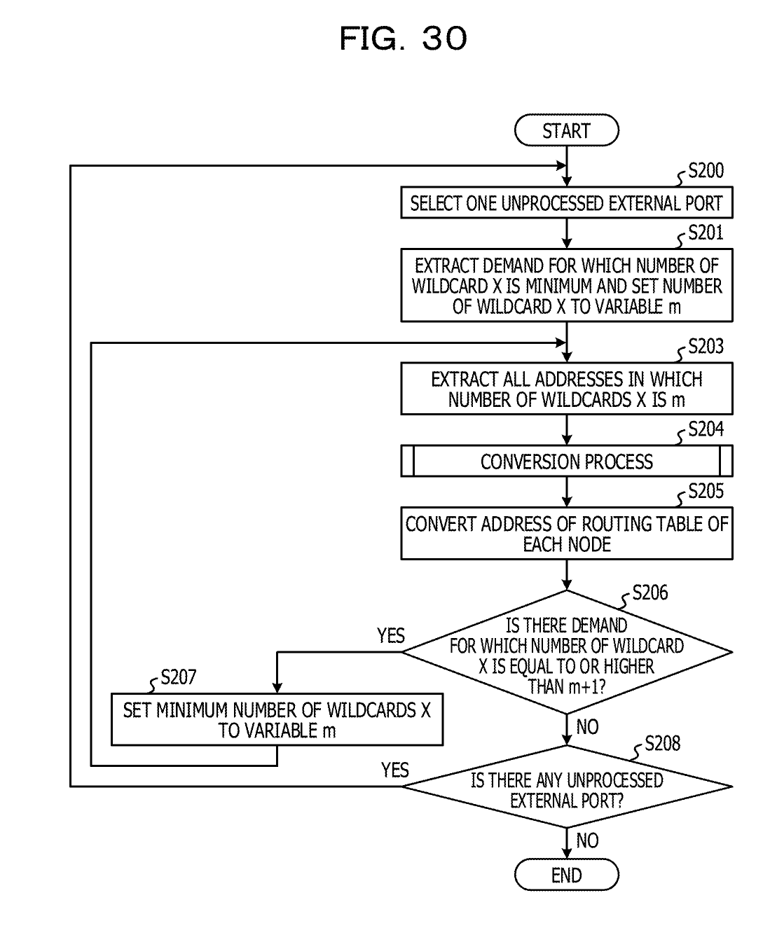

Flow of a generation process in which the routing table verification device 10 according to the example 3 generates an undemanded packet is described. FIG. 30 is a flow chart illustrating one example of a generation process procedure according to the example 3. This generation process is added as a subroutine and performed after, for example, the process of S10 of the verification process illustrated in FIG. 13 or after S100 of the verification process illustrated in FIG. 19.

As illustrated in FIG. 30, the conversion unit 47 selects one unprocessed external port of a network 14 configured to perform verification. Then, the conversion unit 47 extracts all demands having the selected external port as an input, from the demand information 31 (S200). Of the demands extracted in S200, the conversion unit 47 sets to a variable m the number of bits of the wildcard X in an address for which the number of bits of the wildcard X included in the address is a minimum (S201). Of the demands extracted in S200, the conversion unit 47 extracts all demands for which the number of bits of the wildcard X included in the address corresponds to the variable m (S203) The conversion unit 47 performs an address conversion process on the demands extracted in S200 (S204).

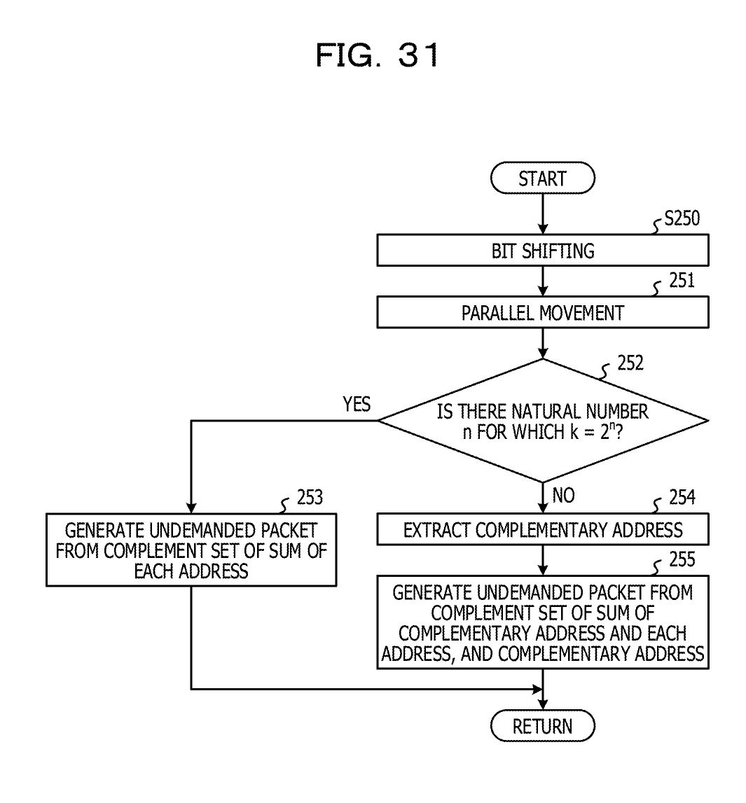

FIG. 31 is a flow chart illustrating one example of a conversion process procedure according to the example 3. This conversion process is performed from S204 of the generation process, for example.

As illustrated in FIG. 31, the conversion unit 47 performs bit shifting that changes to a same position all bits of the m wildcards X, the m being the variable, included in the address of each demand extracted in S203 (S250). For example, the conversion unit 47 performs bit shifting that shifts to the side of the least significant bit (LSB) in the address the bits of the m wildcards X, the m being the variable, included in the address of each demand. The conversion unit 47 performs conversion to move in parallel bit strings other than the bits of the wildcard X of the address of each demand so that the bit strings sequentially represent adjacent addresses (S251). For example, the conversion unit 47 converts the bit strings other than the bits of the wildcard X of the address of each demand so that the bit strings are sequential numbers from 00 . . . 0.

The generation unit 42 determines whether or not there is a natural number n for which the number k of addresses of demands extracted in S203 is 2ⁿ (S252). If there is the natural number n (S252 affirmative), the generation unit 42 generates an undemanded packet having, as an address, an address of a complement set of a sum of the converted addresses of the demands (S253), finishes the conversion process, and proceeds to S205 of the generation process.

On the one hand, when there is no natural number n (S252 negative), the generation unit 42 determines a complementary address that complements the converted address of the demands such that an address indicating a sum of the converted addresses of the demands is one address when the wildcard X is used (S254). Then, the generation unit 42 generates an undemanded packet having addresses one of which is a complement set of a sum of the complementary address and the addresses of the demands, and the other of which is the complementary address (S255), finishes the conversion process, and proceeds to S205 of the generation process.

Turning back to FIG. 30, the conversion unit 47 converts the address of the routing table 32 of each node, corresponding to conversion of the address of each demand in the conversion process (S205).

The conversion unit 47 determines whether or not the demand extracted in S200 has the number of bits of the wildcard X included in the address that is equal to or higher than the variable m+1 (S206). If there is the number of bits of the wildcard X that is equal to or higher than the variable m+1 (S206 affirmative), the conversion unit 47 sets to the variable m the number of bits of the wildcard X which is a minimum of the number of bits of the wildcard X for which the number of bits of the wildcard X is equal to or higher than the variable m+1 (S207), and proceeds to S203 described above.

On the one hand, there is not the number of bits of the wildcard X that is equal to or higher than the variable m+1 (S206 negative), the conversion unit 47 determines whether or not there is any unprocessed external port in the network 14 configured to perform verification (S208). If there is any unprocessed external port (S208 affirmative), the conversion unit 47 proceeds to S200 described above.

On the one hand, if there is no unprocessed external port (S208 negative), the processing ends.

As described above, the routing table verification device 10 according to this example generates an undemanded packet of an address which is a complement set of an address of a communication route of a demand. Based on the routing table of each node of a network, the routing table verification device 10 calculates a transfer route of the generated undemanded packet. The routing table verification device 10 verifies from a calculation result whether the undemanded packet is dropped at any node of the network without being transferred. With this, the routing table verification device 10 may easily verify that any undemanded packet is not transferred in the network.

When there are a plurality of demands, the routing table verification device 10 according to this example converts the addresses of the communication routes of demands such that the addresses are in adjacent address spaces, and also converts the addresses of the routing tables of the nodes, corresponding to the conversion of the addresses. The routing table verification device 10 generates an undemanded packet of an address that is a complement set of a sum of the converted addresses of the demands. The routing table verification device 10 calculates a transfer route of the undemanded packet based on the routing table of each address-converted node. With this, even when there are a plurality of demands and the addresses of the demand are dispersed, the routing table verification device 10 may perform verification outside the demands with a small number of undemanded packets. With this, the routing table verification device 10 may control increase in verification time taken for verification outside the demands.

The routing table verification device 10 according to this example determines a complementary address that complements the converted address of the demands such that an address indicating a sum of the converted addresses of the demands is one address when the wildcard X is used. The routing table verification device 10 generates an undemanded packet having addresses one of which is a complement set of a sum of the complementary address and the addresses of the demands, and the other of which is the complementary address. With this, even if a sum of the address of each demand may not be expressed by one address when the wildcard is used, the verification outside the demands may be performed with the small number of undemanded packets. With this, the routing table verification device 10 may control increase in verification time taken for verification for undemand.

### EXAMPLE 4

While so far the examples related to the disclosed device have been described, the disclosed technology may be carried out in various different forms, in addition to the examples. Thus, other examples included in the embodiments are described hereinafter.

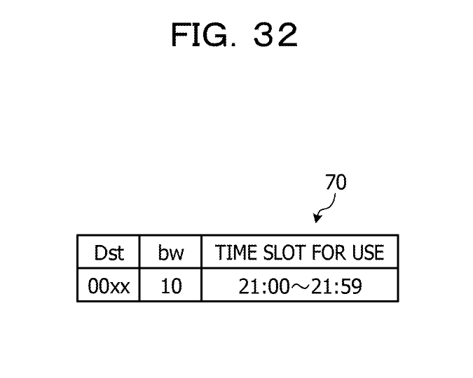

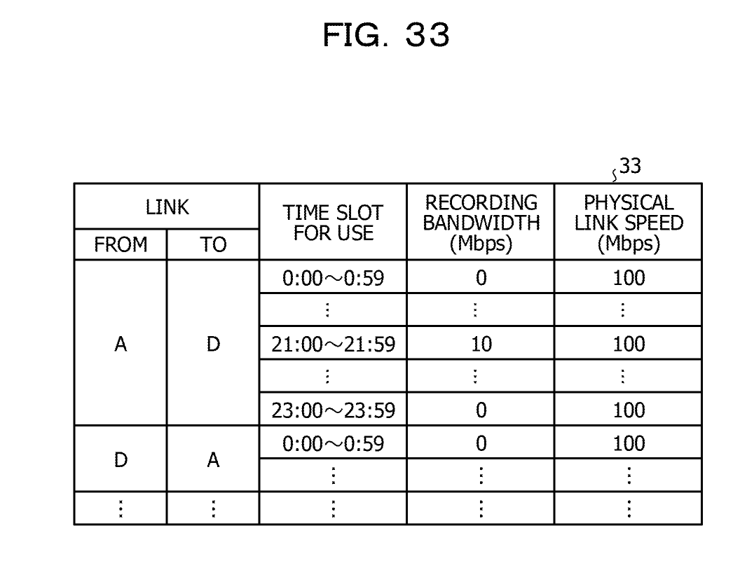

For example, in the examples described above, the case of summing up the bandwidths of packets transferred through a link, in the area in the link bandwidth management table 33 of recording bandwidth of the link is described. However, the disclosed device is not limited to this. For example, information on time slot during which a bandwidth is used may be included in a packet, and bandwidths of packets transferred through a link may be summed up in the link bandwidth management table 33 by time slot. For example, information on time slot during which a bandwidth is used is set in a demand, and the generation unit 2 generates a packet including information on a bandwidth to be used, by time slot in which the bandwidth is used. The example of FIG. 32 illustrates a packet 70 with “00xx” as Dst of the header, “10” as bw, and “21:00 to 21:59” as used time slot during which a bandwidth is used. The bandwidth verification device 45 sums up the bandwidths of packets passing through a link, in the link bandwidth management table 33. FIG. 33 is a diagram illustrating one example of a data configuration of a link band management table. In the example of FIG. 33, the time slot item is further provided, and the bandwidths of the packets passing through the link are summed up by time slot. For example, for the link from the node A to the node D, a total bandwidths of 10 Mbps is recorded in the used time slot of “21:00 to 21:59”. The bandwidth verification device 45 verifies consistency of the bandwidth amount of the link and the summed-up bandwidth for each time slot. With this, the bandwidth verification unit 45 may verify consistency of the bandwidth amount of the link, for each time slot in which the network 14 is used. Even in the example 2, by including time slot for use of each demand in the demand list, consistency of the bandwidth amount of the link may be verified for each time slot in which the network 14 is used.

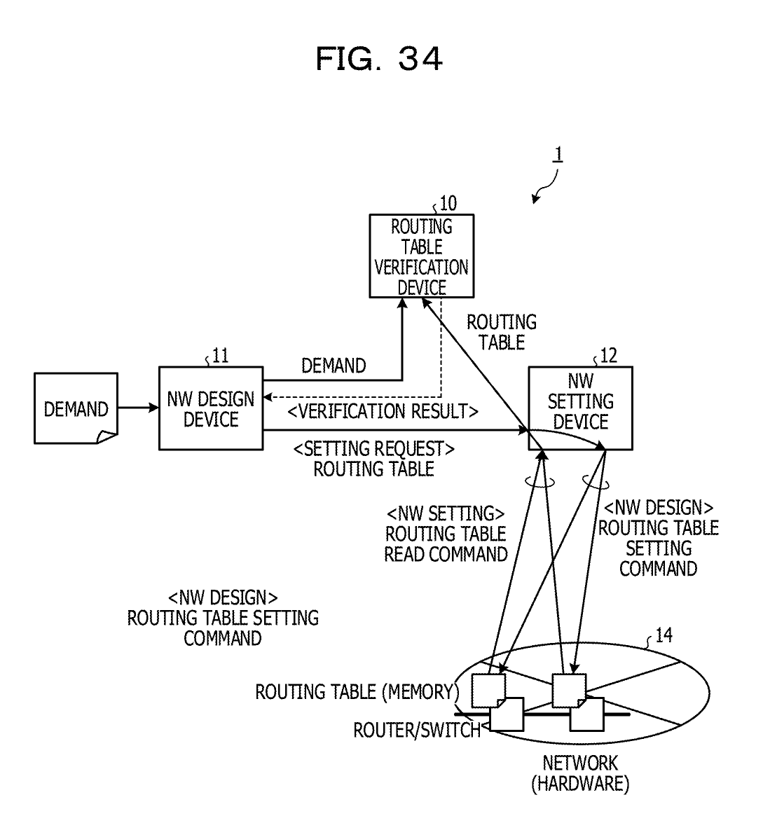

In the examples described above, the case in network designing of verifying whether a routing table before being set for the actual network 14 satisfies a demand. However, the disclosed device is not limited to this. For example, it may be verified whether a routing table set for an actual network 14 satisfies the demand. FIG. 34 is a diagram schematically illustrating an example of verifying whether a routing table set for a network satisfies a demand. The NW setting device 12 collects a routing table from each node, such as a router or a switch or the like of the network, and transmits the routing table to the routing table verification device 10. The NW design device 11 transmits information on a specified demand to the routing table verification device 10. The routing table verification device 10 may verify whether or not a routing table set for the network 14 satisfies a demand inputted from the NW setting device 11. With this, the routing table verification device 10 may verify whether a routing table set for the actual network 14 satisfies the demand.

In the examples described above, the case of identifying a transfer destination from a destination address included in the packet header is described, the disclosed device is not limited to this. For example, a transfer destination may be identified by using a transmission source address, a protocol number, service type (ToS value), VLAN number, destination port number (TCP/UDP), transmission source port number (TCP/UDP).

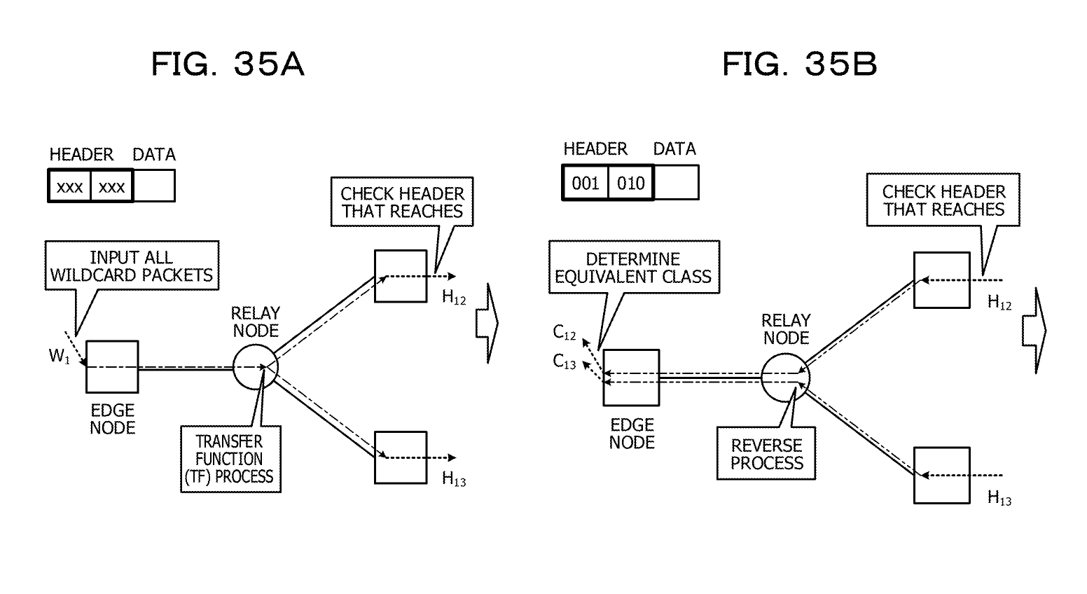

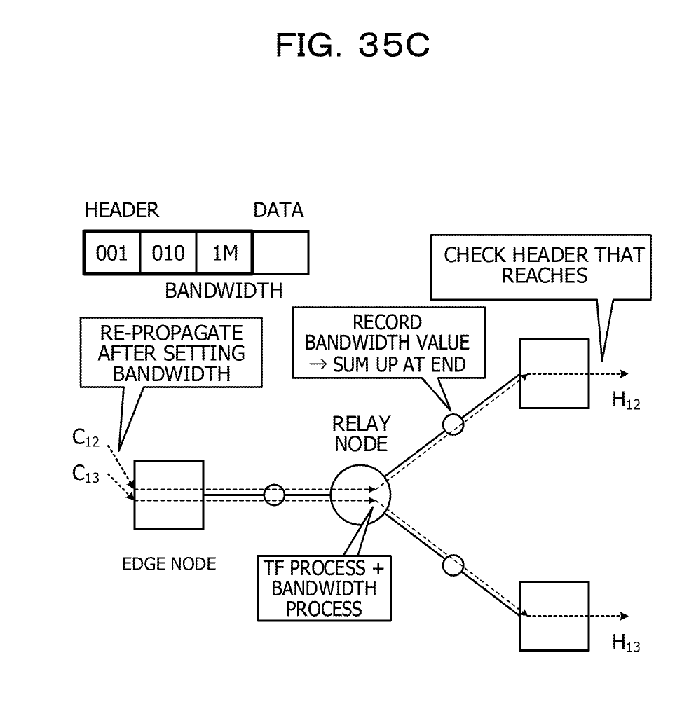

The routing table verification device 10 may verify whether a routing table satisfies a demand, with the following procedure. FIG. 35 is a diagram schematically illustrating other example of verification flow. The routing table verification device 10 calculates a transfer route by inputting from all external ports a packet having a destination address as all wildcard, and checks for occurrence of a loop and reachability from the header that reaches the edge node (FIG. 35(A)). Then, the routing table verification device 10 reversely follows the transfer route of the packet that reaches the edge node. For example, the routing table verification device 10 switches a transmission route address and a destination address of the packet that reaches the edge node, and performs a reverse process to reversely follow a transfer route. Then, as a result of the reverse process, the routing table verification device 10 performs an equivalent class verification of whether a packet returns to an input node through a completely same transfer route (FIG. 35(B)). The routing table verification device 10 sets bandwidth information on a demand corresponding to the equivalent class, propagates the packet again, and sums up bandwidths of the passing packets for every link, and record the bandwidths. Then, the routing table verification device 10 verifies a bandwidth on whether bandwidths summed up for each link exceeds the link speed, after propagating all packets (FIG. 35(C)).

In the examples described above, the case in which three devices of the routing table verification device 10, the NW design device 11, and the NW setting device 12 constitute the system 1 is described. However, the disclosure is not limited to these and may be changed as appropriate. For example, the routing table verification device 10, the NW design device 11, and the NW setting device 12 may be integrated/distributed. For example, the routing table verification device 10, the NW design device 11, and the NW setting device 12 may be integrated into one device.

Each component of each device as illustrated is functionally conceptual, and not requested to be physically configured as illustrated. More specifically, a specific state of distribution/integration of respective devices is not limited to those as illustrated, and all or some of the components may be configured by functionally and physically being distributed/integrated in an arbitrary unit, depending on various loads or use status or the like. For example, each processing unit of the acquisition unit 40, the acceptance unit 41, the generation unit 42, the calculation unit 43, the route verification unit 44, the bandwidth verification unit 45, the output unit 46, and the conversion unit 47 may be integrated, as appropriate. Processing of each processing unit may be separated to processing of a plurality of processing units, as appropriate. Furthermore, each processing function to be performed in each processing unit is implemented by a CPU or a program that is analyzed and executed by the CPU, or may be implemented as hardware such as wired logic or he like.

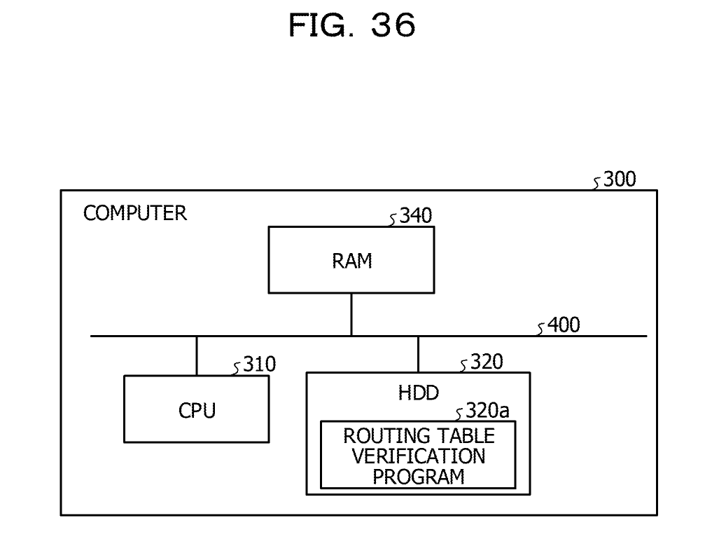

Various processes described in the above examples may also be implemented by executing a program prepared in advance by a computer system such as a personal computer or a workstation. Thus, in the following, one example of a computer system that executes a program having functions similar to the examples described above is described. FIG. 36 is a diagram illustrating a computer configured to execute a routing table verification program.

As illustrated in FIG. 36, a computer 300 has a central processing unit (CPU) 310, a hard disk drive (HDD) 320, and a random access memory (RAM) 340. Each unit of these 300 to 340 is connected by way of a bus 400.

In the HDD 320 is stored in advance a routing table verification program 320a that demonstrates functions similar to the acquisition unit 40, the acceptance unit 41, the generation unit 42, the calculation unit 43, the route verification unit 44, the bandwidth verification unit 45, the output unit 46, and the conversion unit 47 described above. The routing table verification program 320a may be separated as appropriate.

The HDD 320 is configured to store various information. For example, the HDD 320 stores various data to be used in an OS or analysis.

Then, reading a routing table verification program 320a from the HDD 320 and executing the program, the CPU 310 performs operations similar to each processing unit of the examples. More specifically, the routing table verification program 320a performs operations similar to the acquisition unit 40, the acceptance unit 41, the generation unit 42, the calculation unit 43, the route verification unit 44, the bandwidth verification unit 45, the output unit 46, and the conversion unit 47.

The routing table verification program 320a described above is not requested to be stored in the HDD 320 from the beginning.

For example, a program is stored in a “portable physical medium” such as a flexible disk (FD), a CD-ROM, a DVD disk, an a magneto-optical disk, an IC card, or the like, which are inserted into the computer 300. Then, the computer 300 may read a program from these and execute the program.

Furthermore, a program is stored in “other computer (or server)” or the like, to be connected to the computer 300 by way of a public circuit, Internet, LAN, WAN, or the like. Then, the computer 300 may read the program from these and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device, comprising:
a memory; and
a processor coupled to the memory and configured to:
generate a packet including a transmission source address, a destination address, and bandwidth information which correspond to a communication route and a bandwidth, based on a request to a network for allocation of the communication route and the bandwidth,
specify a transfer route of the generated packet, based on routing tables respectively owned by a plurality of nodes on the network, and
determine whether the specified transfer route matches the communication route, based on a transmission source address and a destination address of a packet that reaches a final node using the transfer route.

2. The information processing device according to claim 1, wherein the processor is configured to:
sum up a bandwidth of each of a plurality of links formed by a plurality of nodes, based on the specified transfer route and bandwidth information of the packet, and
determine whether the summation result is equal to or less than a bandwidth amount of the link.

3. The information processing device according to claim 1, wherein the processor is configured to:
generate a plurality of packets by generating a packet for each of a plurality of the requests, the packet including a transmission source address, a destination address, and bandwidth information which correspond to a communication route and a bandwidth,
specify a transfer route for each of the plurality of packets,
determine, for each of packets that reach the final nodes using the respective transfer routes specified, whether the transfer route of the packet matches the communication route of the request corresponding to the packet, among the plurality of requests, based on a transmission source address and a destination address of the packet,
sum up, for each of a plurality of links included in the network, a bandwidth of a packet passing through the link, and
determine whether the summation result is equal to or less than a bandwidth amount of the link.

4. The information processing device according to claim 1, wherein the processor is configured to:
generate a packet including a transmission source address, a destination address, and bandwidth information which correspond to the communication route and the bandwidth of each of a plurality of the requests;
specify a plurality of transfer destinations by identifying a transfer destination corresponding to a destination address of each of the requests included in the generated packets based on the routing tables of the plurality of nodes on the network;
specify a transfer route for each of the plurality of transfer destinations, by transferring a packet including the transmission source address, the destination address, and the bandwidth information of the request for which the transfer destination is specified,
sum up, for each of a plurality of links included in the network, a bandwidth included in a packet passing through the link, and
determine whether the summation result is equal to or less than a bandwidth amount of the link.

5. The information processing device according to claim 1, wherein the processor is configured to:
generate the packet including the bandwidth information used for each time slot,
sum up a bandwidth of a packet passing through a link for each time slot, and
determine for each time slot whether the summation result is included in the bandwidth amount of the link.

6. The information processing device according to claim 1, wherein the processor is configured to:
generate an undemanded packet of an address that is a complement set of an address of the communication route of the request,
specify a transfer route of the generated undemanded packet based on the routing tables of the nodes in the network, and
determine whether the undemanded packet is dropped without being transferred at any node in the network, based on the specified result of the transfer route.

7. The information processing device according to claim 6, wherein the processor is configured to:
when there are a plurality of the requests,
convert the addresses of the communication routes of the requests such that the addresses indicate adjacent address spaces, and convert addresses of the routing tables of the nodes corresponding to the address conversion,
generate an undemanded packet of an address that is a complement set of a sum of the converted addresses of the requests, and
calculate a transfer route of the undemanded packet based on the routing tables of the nodes including the converted addresses.

8. The information processing device according to claim 7, wherein the processor is configured to:
determine a complementary address that complements the converted addresses of the requests such that an address indicating a sum of the converted addresses of the requests is one address when a wildcard is used, and
generate an undemanded packet having addresses one of which is an address that is a complement set of a sum of the complementary address and the addresses of the requests, and the other of which is the complementary address.

9. A route verification method executed by a processor included in an information processing device, the route verification method comprising:
generating a packet including a transmission source address, a destination address, and bandwidth information which correspond to a communication route and a bandwidth, based on a request to a network for allocation of the communication route and the bandwidth;
specifying a transfer route of the generated packet based on routing tables respectively owned by a plurality of nodes on the network; and
determining whether the specified transfer route matches the communication route, based on a transmission source address and a destination address of a packet that reaches a final node using the transfer route.

10. An information processing device, comprising:
a memory; and
a processor coupled to memory and configured to:
generate a packet of an address that is a complement set of an address of a communication route based on a request to a network for allocation of the communication route,
specify a transfer route of the packet generated by the generation unit, based on routing tables of nodes on the network, and
determine whether the packet is dropped without being transferred at any node on the network, based on the specified transfer route.

11. The information processing device according to claim 10, wherein the processor is configured to:
when there are a plurality of the requests,
convert the addresses of the communication routes of the requests such that the addresses indicate adjacent address spaces, and convert addresses of the routing tables of the nodes corresponding to the address conversion,
generate an undemanded packet of an address that is a complement set of a sum of the converted addresses of the requests, and
calculate a transfer route of the undemanded packet based on the routing tables of the nodes including the converted addresses.

12. The information processing device according to claim 11, wherein the processor is configured to:
determine a complementary address that complements the converted addresses of the requests such that an address indicating a sum of the converted addresses of the requests is one address when a wildcard is used, and
generate an undemanded packet having addresses one of which is an address that is a complement set of a sum of the complementary address and the addresses of the requests, and the other of which is the complementary address.

13. A verification method of a route on a network, executed by a processor included in an information processing device, the verification method comprising:
generating a packet of an address that is a complement set of an address of a communication route, based on a request to the network for allocation of the communication route;
specifying a transfer route of the generated packet, based on routing tables of nodes on the network; and
determining whether the packet is dropped without being transferred at any node on the network, based on the specified transfer route.

14. A system, comprising:
a network design device; and
an information processing device coupled to the network design device,
wherein the network design device is configured to
transmit a request related to a network for allocation of a communication route and a bandwidth to the information processing device, and
wherein the network design device is configured to:
generate a packet including a transmission source address, a destination address, and bandwidth information which correspond to a communication route and a bandwidth, in response to the request,
specify a transfer route of the generated packet, based on routing tables respectively owned by a plurality of nodes on the network, and
determine whether the specified transfer route matches the communication route, based on a transmission source address and a destination address of a packet that reaches a final node using the transfer route, and
transmit a result of determining whether the specified transfer route matches the communication route to the network design device, and
wherein the network design device is configured to design the network based on the result.
